(19) United States
(12) Patent Application Publication
(10) Pub. No.: US 2026/0106409 A1
(43) Pub. Date: Apr. 16, 2026

(54) CONNECTOR, MATING CONNECTOR, AND CONNECTOR ASSEMBLY

(71) Applicant: Panasonic Intellectual Property Management Co., Ltd., Osaka (JP)

(72) Inventors: HIROKI UEDA, Mie (JP); GO SAKANO, Mie (JP)

(21) Appl. No.: 19/110,045

(22) PCT Filed: Sep. 14, 2023
(86) PCT No.: PCT/JP2023/033557

§ 371 Date: Dec. 26, 2025

(30) Foreign Application Priority Data
Oct. 12, 2022 (JP) 2022-164299

(51) Int. Cl. H01R 13/639; H01R 12/71; H01R 13/11; H01R 13/187

(52) U.S. Cl. CPC H01R 13/639; H01R 12/712; H01R 13/114; H01R 13/187

(57) ABSTRACT

A connector includes a housing including a peripheral wall, a holding metal fitting disposed at an end of the peripheral wall, and a terminal held by the peripheral wall and electrically connected to a mating terminal of a mating connector. The holding metal fitting includes an end piece including an upper part and an inner part, a side piece including an upper part and an inner part, a coupling part disposed at a corner of the peripheral wall, the coupling part coupling the end piece and the side piece to each other, a bottom extending from a lower end of the end piece or a lower end of the side piece, and a spring piece extending upward from the bottom. The coupling part includes an inner coupling part connecting the inner part of the end piece and the inner part of the side piece without discontinuities.

### TECHNICAL FIELD

The present disclosure generally relates to connectors, mating connectors, and connector assemblies. More specifically, the present disclosure relates to a connector to be fitted to a mating connector, a mating connector to be fitted to the connector, and a connector assembly including the connector and the mating connector.

### BACKGROUND ART

PTL 1 discloses a receptacle connector. The receptacle connector of PTL 1 includes a receptacle insulator, a plurality of receptacle contacts, and a receptacle-side fixing metal fitting. The receptacle insulator is made of resin and has an annular outer peripheral wall forming a fitting recess on the inner peripheral side. The plurality of receptacle contacts can be mounted on a circuit pattern of a receptacle-side circuit board and are supported by the receptacle insulator. The receptacle-side fixing metal fitting can be mounted on the receptacle-side circuit board and is supported by the receptacle insulator. In the receptacle connector, when a fitting protrusion of a plug insulator of a plug connector is fitted into the fitting recess, a plurality of plug contacts mountable on a circuit pattern of a plug-side circuit board and supported by the plug insulator come into contact with the receptacle contact, and the plug connector comes into contact with the receptacle-side fixing metal fitting. The receptacle-side fixing metal fitting and the receptacle insulator are integrated by insert molding. The receptacle-side fixing metal fitting includes an elastic contact piece. The elastic contact piece is separated from the inner peripheral surface of the outer peripheral wall toward the inner peripheral side in a free state.

### CITATION LIST

### Patent Literature

PTL 1: Unexamined Japanese Patent Publication No. 2015-99694

### SUMMARY OF THE INVENTION

A connector such as the receptacle connector of PTL 1 may be desired to be hardly damaged at the time of fitting.

An object of the present disclosure is to provide a connector, a mating connector, and a connector assembly that are less likely to be damaged at the time of fitting.

A connector according to one aspect of the present disclosure is a connector to be fitted to a mating connector, the connector including: a housing including a peripheral wall, the peripheral wall including a first end wall and a second end wall facing each other in a first axis, a first side wall coupling one end of the first end wall and one end of the second end wall, and a second side wall coupling an other end of the first end wall and an other end of the second end wall; a holding metal fitting disposed at, out of a first end of the peripheral wall in the first axis and a second end opposite to the first end, the first end; and a terminal held by the peripheral wall and electrically connected to a mating terminal of the mating connector, in which the connector is fitted to the mating connector when the connector moves upward, the holding metal fitting includes: an end piece including an upper part disposed above the first end wall and an inner part disposed inside the first end wall; a side piece including an upper part disposed above the first side wall and an inner part disposed inside the first side wall; a coupling part disposed at a corner of the peripheral wall where the first end wall and the first side wall are connected to each other, the coupling part coupling the end piece and the side piece to each other; a bottom located between the first side wall and the second side wall, the bottom extending from a lower end of the end piece or a lower end of the side piece; and a spring piece extending upward from the bottom, and the coupling part includes an inner coupling part connecting the inner part of the end piece and the inner part of the side piece without discontinuities.

A mating connector according to one aspect of the present disclosure is a mating connector to be fitted to the connector described above, the mating connector including: a mating housing including a mating peripheral wall, the mating peripheral wall including a first mating end wall and a second mating end wall facing each other, a first mating side wall coupling one end of the first mating end wall and one end of the second mating end wall, and a second mating side wall coupling an other end of the first mating end wall and an other end of the second mating end wall; a mating holding metal fitting disposed at the first end of the mating peripheral wall in the first axis; and the mating terminal, in which the mating holding metal fitting includes: a mating end piece including an upper part disposed above the first mating end wall and an outer part disposed outside the first mating end wall; a mating side piece including an upper part disposed above the first mating side wall and an outer part disposed outside the first mating side wall; and a mating coupling part disposed at a corner of the mating peripheral wall where the first mating end wall and the first mating side wall are connected, the mating coupling part coupling the mating end piece and the mating side piece, and the mating coupling part includes an outer coupling part coupling the outer part of the mating end piece and the outer part of the mating side piece without discontinuities.

A connector assembly according to one aspect of the present disclosure is a connector assembly including a socket and a header to be fitted to the socket, in which the socket is the connector of the aspect described above, and the header is the mating connector of the aspect described above.

The connector, the mating connector, and the connector assembly of the present disclosure have the advantage of being less likely to be damaged at the time of fitting.

### BRIEF DESCRIPTION OF THE DRAWINGS

FIG. 1 is a perspective view of a connector assembly including a connector and a mating connector according to an exemplary embodiment.

FIG. 2 is an exploded perspective view of a main part of the connector.

FIG. 3 is a perspective view of a holding metal fitting included in the connector.

FIG. 4 is a perspective view of the holding metal fitting.

FIG. 5 is a plan view of the holding metal fitting.

FIG. 6 is a perspective view of a main part of the connector.

FIG. 7 is a sectional view of the connector.

FIG. 8 is a sectional view illustrating a state after the connector is connected to the mating connector in the connector assembly.

FIG. 9 is a perspective view of the connector assembly.

FIG. 10 is an exploded perspective view of a main part of the mating connector.

FIG. 11 is a perspective view of a mating holding metal fitting included in the mating connector.

FIG. 12 is a perspective view of the mating holding metal fitting.

FIG. 13 is a sectional view illustrating a state before the connector is connected to the mating connector in the connector assembly.

FIG. 14 is a perspective view of a holding metal fitting of a first modification.

FIG. 15 is a perspective view of a holding metal fitting of a second modification.

### DESCRIPTION OF EMBODIMENT

### Exemplary Embodiments

Hereinafter, an exemplary embodiment of the present disclosure will be described. The exemplary embodiment described below is merely an example of various exemplary embodiments of the present disclosure. The following exemplary embodiment can be variously changed in accordance with a design and the like as long as the object of the present disclosure can be achieved. The drawings described in the following exemplary embodiment are schematic views, and the ratio of the size and the thickness of each component in the drawings is not necessarily reflected in the actual dimensional ratio.

### (1) Overview

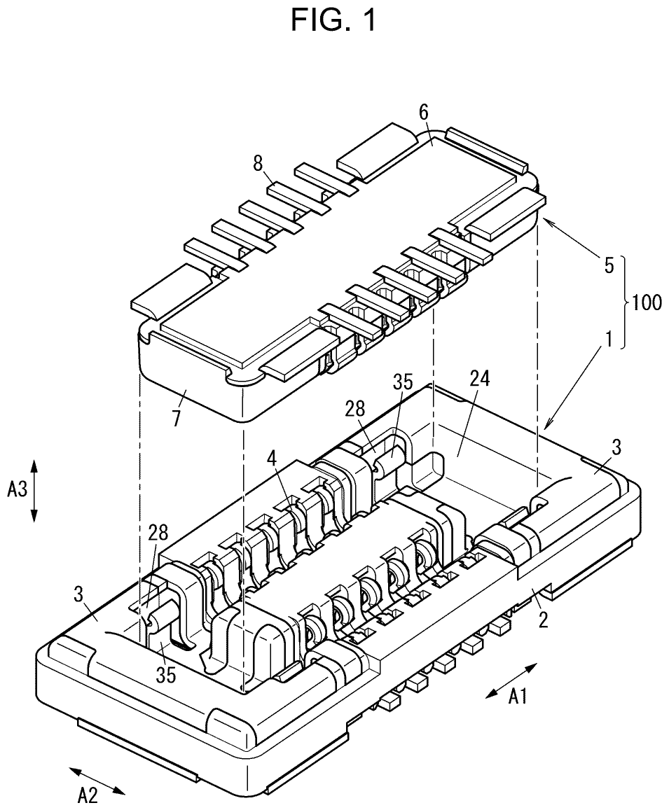

As illustrated in FIG. 1, connector assembly 100 of the present exemplary embodiment includes connector 1 as a socket (female connector; receptacle) and mating connector 5 as a header (male connector; plug). The header is to be fitted into the socket.

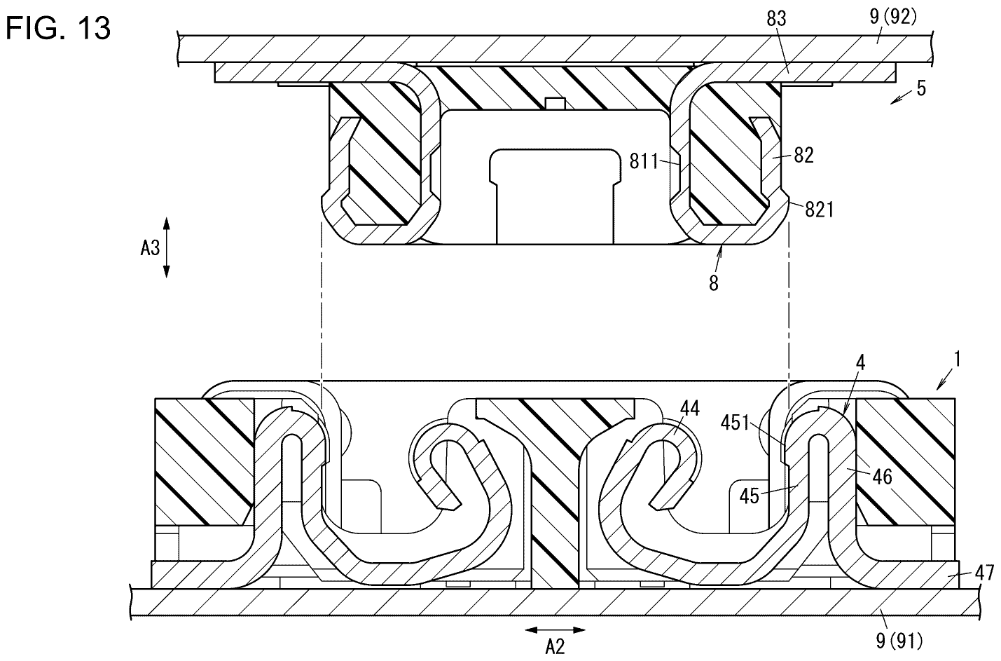

Connector assembly 100 is used to electrically connect a plurality of substrates 9 (see FIG. 13 described later) mounted on an electronic device, for example. Connector 1 is mounted on, for example, substrate 9 (hereinafter, also referred to as “first substrate 91”) built in an electronic device. Mating connector 5 is mounted on another substrate 9 (hereinafter, also referred to as “second substrate 92”) also built in the electronic device. The electronic device is, for example, a mobile terminal such as a smartphone.

As illustrated in FIG. 1, connector 1 includes housing 2, holding metal fitting 3, and terminal 4.

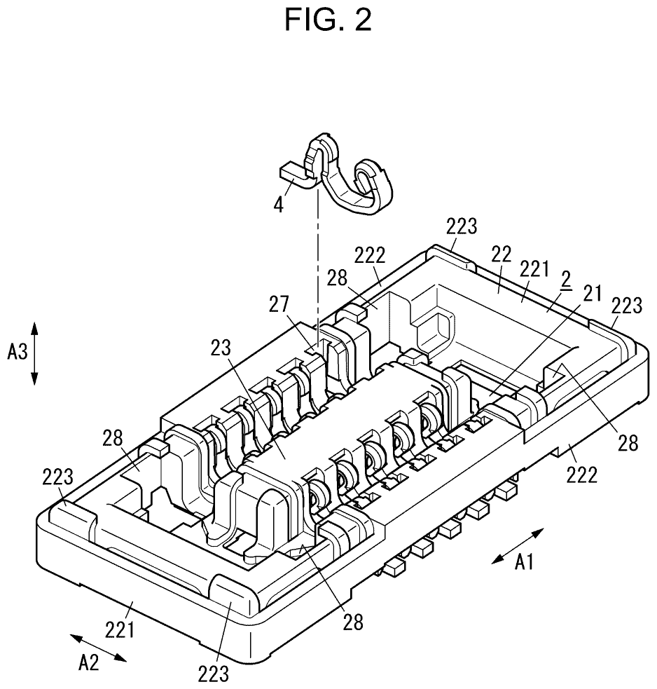

As illustrated in FIG. 2, housing 2 includes peripheral wall 22 and bottom wall 21. Peripheral wall 22 has a pair of end walls 221 and a pair of side walls 222. Peripheral wall 22 has a rectangular shape as viewed along third axis A3. The pair of end walls 221 extends along second axis A2 and faces each other along first axis A1. Second axis A2 intersects (here, is orthogonal to) first axis A1. The pair of side walls 222 is located at both ends of the pair of end walls 221 in second axis A2. Both ends of each of the pair of end walls 221 are connected to the pair of side walls 222. The pair of side walls 222 extends along first axis Al and faces each other along second axis A2. Each of the pair of side walls 222 connects ends (ends in second axis A2) of the pair of end walls 221. The portion where end wall 221 and side wall 222 are connected is a corner 223. Each of the pair of side walls 222 does not have to connect the ends (ends in second axis A2) of the pair of end walls 221.

Holding metal fitting 3 is disposed at, out of a first end of peripheral wall 22 in first axis A1 and a second end opposite to the first end, the first end. The “first end of peripheral wall 22 in first axis A1” herein is one end of peripheral wall 22 in first axis A1, and the “second end of peripheral wall 22 in first axis A1” herein is the other end of peripheral wall 22 in first axis A1.

Terminal 4 is held by peripheral wall 22. Terminal 4 is electrically connected to mating terminal 8 of mating connector 5.

As illustrated in FIG. 1, connector 1 is fitted to mating connector 5 by moving upward along third axis A3 with respect to mating connector 5. Third axis A3 intersects (here, is orthogonal to) both first axis A1 and second axis A2.

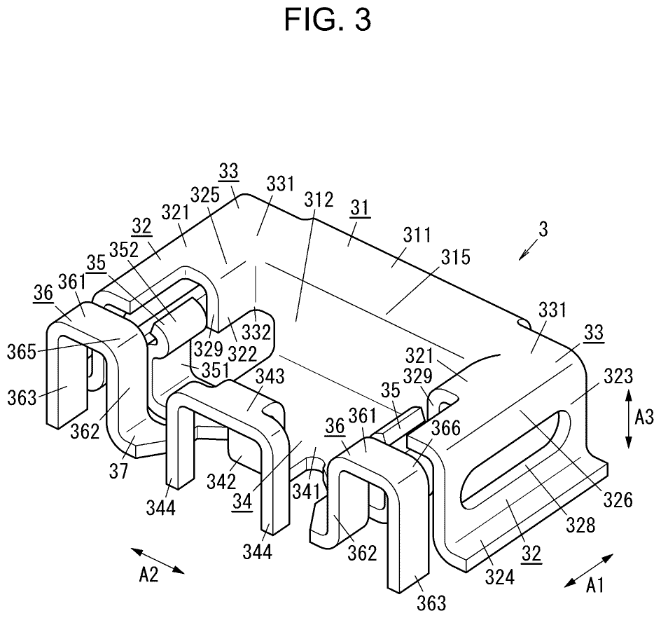

As illustrated in FIGS. 3 to 5, holding metal fitting 3 includes end piece 31, side piece 32, coupling part 33, bottom 341, and spring piece 35.

End piece 31 has upper part 311 and inner part 312. Upper part 311 is disposed on the upper side of one end wall 221 of the pair of end walls 221, and inner part 312 is disposed inside the one end wall 221.

Side piece 32 has upper part 321 and inner part 322. Upper part 321 is disposed on the upper side of one side wall 222 of the pair of side walls 222, and inner part 322 is disposed inside the one side wall 222.

Coupling part 33 couples end piece 31 and side piece 32 at corner 223 of peripheral wall 22. Coupling part 33 includes inner coupling part 332. Inner coupling part 332 connects inner part 312 of end piece 31 and inner part 322 of side piece 32 without discontinuities at corner 223 of peripheral wall 22.

Spring piece 35 extends upward from bottom 341 and is configured to be elastically deformable outward.

In connector 1 of the present exemplary embodiment, coupling part 33 includes inner coupling part 332. Thus, connector 1 has an advantage that the strength is improved as compared with the connector (socket) of a comparative example in which inner coupling part 332 is not provided but a slit is provided between inner part 312 and inner part 322. In addition, when mating connector 5 is fitted into fitting recess 24 (see FIG. 1) inside peripheral wall 22 of housing 2, the possibility that the inner surface of corner 223 of peripheral wall 22 is damaged by the metal portion provided in mating connector 5 is reduced. Consequently, connector 1 of the present exemplary embodiment has an advantage that damage to be generated at the time of fitting can be reduced.

Further, in connector 1 of the present exemplary embodiment, holding metal fitting 3 includes spring piece 35. Thus, spring piece 35 exhibits an effect of ensuring reliability of contact between holding metal fitting 3 and mating holding metal fitting 7. As a result, it is not necessary to bring portions of holding metal fitting 3 other than spring pieces 35 into planar firm contact with mating holding metal fitting 7, and it is possible to alleviate the insertion and removal force when mating connector 5 is fitted to connector 1. The “insertion and removal force” in the present disclosure is a force required for fitting mating connector 5 to connector 1 and/or detaching mating connector 5 from connector 1. Consequently, connector 1 of the present exemplary embodiment has an advantage that it is less likely to be damaged at the time of fitting. The term “at the time of fitting” in the present disclosure means at least one of the case where mating connector 5 is fitted to connector 1 and the case where mating connector 5 is detached from connector 1.

### (2) Detailed Configuration

Hereinafter, a detailed configuration of connector assembly 100 of the present exemplary embodiment will be described with reference to the drawings. As described above, connector assembly 100 includes connector 1 as a socket and mating connector 5 as a header.

### (2-1) Socket

A detailed configuration of connector 1 as a socket will be described with reference to FIGS. 1 to 8.

Connector 1 is formed in a flat rectangular box shape having a length along first axis A1, a width along second axis A2 intersecting (here, orthogonal to) first axis A1, and a height along third axis A3 intersecting (here, orthogonal to) both first axis A1 and second axis A2. Mating connector 5 is fitted to connector 1 along third axis A3.

In the column of “(2-1) Socket”, for convenience of description, one side and the other side in first axis A1 are referred to as “left” and “right”, respectively, one side and the other side in second axis A2 are referred to as “front” and “rear”, respectively, and one side and the other side in third axis A3 are referred to as “up” and “down”, respectively. In particular, when connector 1 and mating connector 5 are fitted, the side on which connector 1 is located in third axis A3 is referred to as “down”, and the side on which mating connector 5 is located is referred to as “up”. The above definition of the directions is not intended to limit the use form of connector 1.

In the column of “(2-1) Socket”, in plan view of connector 1, a side close to the center of connector 1 is referred to as “inner side”, and a side far from the center of connector 1 is referred to as “outer side”. That is, the “outer side” refers to a side away from the center with the center of connector 1 as a reference (inner side). In the present disclosure, “plan view”means viewing from “up”.

The length dimension (dimension in first axis A1) of connector 1 is, for example, several mm to several tens of mm. The width dimension (dimension in second axis A2) of connector 1 is, for example, several mm. The height dimension (dimension in third axis A3) of connector 1 is, for example, a comma several mm.

As illustrated in FIG. 1, connector 1 includes housing 2, a pair of holding metal fitting 3, and a plurality of terminals 4.

### (2-1-1) Housing, Terminal

Housing 2 is a resin molding having insulating properties. In the present exemplary embodiment, housing 2 is an insert-molded article including the pair of holding metal fittings 3 as insert articles.

Housing 2 has a flat rectangular parallelepiped shape having a length along first axis A1. As illustrated in FIG. 2, housing 2 includes bottom wall 21, peripheral wall 22, and intermediate base 23. Bottom wall 21, peripheral wall 22, and intermediate base 23 are integrally formed. Bottom wall 21 has a plate shape elongated along first axis A1 and constitutes the bottom of housing 2. Peripheral wall 22 protrudes upward from the peripheral edge of bottom wall 21 and has a rectangular frame shape in plan view. That is, peripheral wall 22 is formed so as to surround the center along the peripheral edge of bottom wall 21.

Peripheral wall 22 includes a pair of end walls 221 and a pair of side walls 222. Peripheral wall 22 has a total of four corners 223 at positions where end wall 221 and side wall 222 are connected.

In each of the pair of side walls 222, a plurality of terminals 4 are stored in a plurality of terminal storages 27 described later, respectively, whereby the plurality of terminals 4 are held in a state of being arranged along first axis A1. In the present exemplary embodiment, the pair of side walls 222 holds a total of 10 terminals 4, that is, 5 terminals 4 for each.

An interval at which the plurality of terminals 4 are arranged, that is, a pitch is, for example, a comma several mm. In the present exemplary embodiment, the plurality of terminals 4 are arranged at equal pitches, but they may be arranged at irregular pitches.

Intermediate base 23 is positioned between the pair of side walls 222 in second axis A2 and extends along first axis A1. Intermediate base 23 has a rectangular parallelepiped shape having a length along first axis A1. Intermediate base 23 protrudes upward from the center of bottom wall 21. A portion surrounded by bottom wall 21, peripheral wall 22, and intermediate base 23 forms fitting recess (hereinafter, also referred to as “first fitting recess”) 24 into which mating connector 5 is to be fitted. Specifically, mating peripheral wall 62, which will be described later, of mating connector 5 is fitted into first fitting recess 24. Consequently, mating connector 5 is connected to connector 1.

The plurality of terminals 4 are terminals for signal transmission. In a state where mating connector 5 is connected to connector 1, terminal 4 is connected to mating terminal 8 (details will be described later) of corresponding mating connector 5.

Terminal 4 is a metal molded body made of a metallic material such as a copper alloy. Terminal 4 is plated with gold, but is not limited thereto, and it does not have to be plated with gold.

As illustrated in FIG. 13, terminal 4 includes curved piece 44, rising piece 45, falling piece 46, and terminal piece 47, which are integrally formed.

Curved piece 44 has a tip curved in a horseshoe shape, and is configured to be elastically deformed along second axis A2. Curved piece 44 is pushed by corresponding mating terminal 8 in a state where mating connector 5 is connected to connector 1.

Consequently, curved piece 44 generates an elastic force in a direction (outward) toward corresponding mating terminal 8.

Rising piece 45 has a plate shape. A first end (lower end) of rising piece 45 is integrated with curved piece 44. Rising piece 45 comes into contact with corresponding mating terminal 8 in a state where mating connector 5 is connected to connector 1. Rising piece 45 is integrated with projection 451 protruding toward curved piece 44. In terminal 4, as illustrated in FIG. 13, in a state where mating connector 5 is connected to connector 1, projection 451 is arranged (vertically) with projection 821 of corresponding mating terminal 8 along third axis A3, and is located on the bottom side of mating terminal 8 with respect to projection 821. That is, projection 451 constitutes a lock mechanism by being caught by projection 821 of corresponding mating terminal 8.

Falling piece 46 has a plate shape. As illustrated in FIG. 13, a first end (upper end) of falling piece 46 is curved in an inverted U shape and is integrated with a second end (upper end) of rising piece 45.

Terminal piece 47 has a plate shape. Terminal piece 47 is integrated with the second end (lower end) of falling piece 46. Terminal piece 47 protrudes outward along second axis A2 from the second end of falling piece 46. The lower surface of terminal piece 47 is exposed from housing 2. The lower surface of terminal piece 47 is a joint surface to be joined to second substrate 92 by soldering, for example.

As illustrated in FIG. 2, housing 2 includes a plurality of (here, 10) terminal storages 27 corresponding to the plurality of terminals 4 on a one-to-one basis. Each of the plurality of terminal storages 27 is formed across side wall 222, bottom wall 21, and intermediate base 23. Each of the plurality of terminal storages 27 penetrates bottom wall 21 along third axis A3. Each of the plurality of terminals 4 is stored in terminal storage 27 by being pushed into terminal storage 27 from below. In this manner, the plurality of terminals 4 are held by being press-fitted into housing 2. The plurality of terminals 4 may be formed integrally with housing 2 by insert molding.

The plurality of terminal storages 27 are equally divided into two on both sides in second axis A2 with intermediate base 23 interposed therebetween. The plurality of terminal storages 27 on both sides of intermediate bases 23 are arranged at substantially equal intervals along first axis A1.

Each of the plurality of terminals 4 is partially exposed to first fitting recess 24 in a state of being stored in terminal storage 27. Specifically, a part of curved piece 44 of each of the plurality of terminals 4 is exposed from a side part of intermediate base 23 to first fitting recess 24. A part of rising piece 45 of each of the plurality of terminals 4 is exposed from the inside of side wall 222 to first fitting recess 24. When mating connector 5 is connected to connector 1, in each of the plurality of terminals 4, a portion exposed in first fitting recess 24 comes into contact with the corresponding one of the plurality of mating terminals 8 of mating connector 5.

As illustrated in FIG. 1, in housing 2, each of the pair of side walls 222 has spring storage 28 that stores corresponding spring piece 35. In the present exemplary embodiment, as illustrated in FIG. 2, in housing 2, two (four in total) spring storage 28 are provided in each of the pair of side walls 222. Two spring storages 28 are provided on both sides in first axis A1 across the plurality of terminal storages 27 in each of the pair of side walls 222. Spring storage 28 is a groove-shaped recessed part formed in side wall 222.

Since each of the pair of side walls 222 has spring storage 28, the space surrounded by peripheral wall 22 of housing 2 can be reduced by a space necessary for accommodating spring piece 35 as compared with a case where housing 2 does not have spring storage 28. That is, there is an advantage that the size of connector 1 can be reduced. One of the pair of side walls 222 may have spring storage 28. That is, at least one of the pair of side walls 222 have spring storage 28.

### (2-1-2) Holding Metal Fitting

Holding metal fitting 3 is, for example, a metal molded body made of a metallic material such as a copper alloy. Holding metal fitting 3 is used to improve the strength of connector 1.

As illustrated in FIG. 1, peripheral wall 22 of housing 2 is provided with one holding metal fitting 3 (two in total) at each of both ends (left end and right end) in first axis A1. Hereinafter, in principle, holding metal fitting 3 attached to the first end (right end) of housing 2 will be described as an example, and holding metal fitting 3 attached to the second end (left end) of housing 2 has the same structure.

Holding metal fitting 3 is integrally formed seamlessly (without any joint) by, for example, drawing.

As illustrated in FIGS. 3 to 5, holding metal fitting 3 includes end piece 31, side piece 32, coupling part 33, intermediate extension 34, spring piece 35, side extension piece 36, and bottom extension 37. Specifically, holding metal fitting 3 includes one end piece 31, two side pieces 32, two coupling parts 33, one intermediate extension 34, two spring pieces 35, two side extension pieces 36, and two bottom extensions 37.

### End Piece

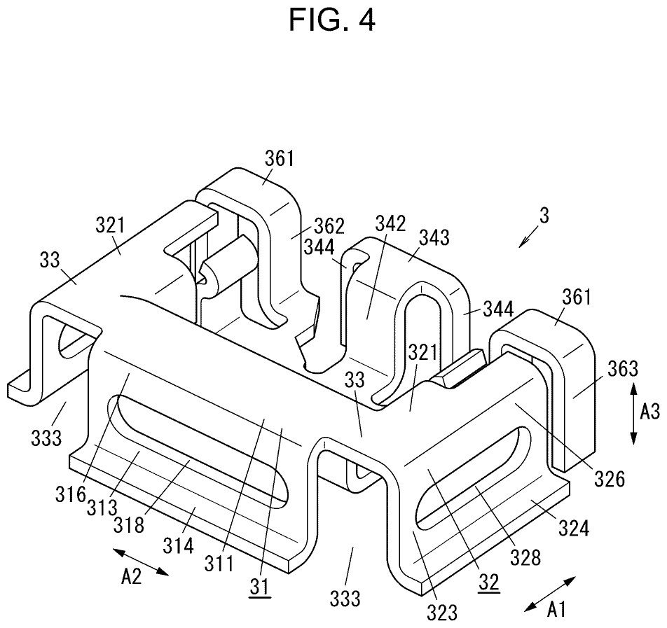

End piece 31 protects one (right) end wall 221 of housing 2. As illustrated in FIG. 3 or 4, end piece 31 includes upper part 311, inner part 312, and outer part 313.

Upper part 311 is disposed on the upper side of end wall 221 and covers at least a part of upper surface of end wall 221. Upper part 311 covers substantially the entire upper surface of end wall 221 (a portion other than corner 223).

Inner part 312 is disposed inside (left side) end wall 221 and covers at least a part of an inner side surface (left side surface) of end wall 221. Inner part 312 covers at least a portion near the upper end of the inner side surface of end wall 221. An inner side surface (left side surface) of inner part 312 is exposed to first fitting recess 24. The inner side surface of inner part 312 is connected to an exposed surface of the inner side surface of end wall 221 that is not covered with inner part 312 without a step (see FIG. 1).

As illustrated in FIG. 3, inner part 312 has a rectangular plate-like first portion having a constant width dimension (dimension in second axis A2) at the upper end thereof. In addition, inner part 312 has a rectangular plate-like second portion having a width dimension smaller than that of the first portion and constant on the lower side of the first portion.

The upper end of inner part 312 is connected to an inner end (left end) of upper part 311. The corner connecting the upper end of inner part 312 and the inner end of upper part 311 is curved part 315.

Outer part 313 is disposed outside (right side) end wall 221 and covers at least a part of an outer side surface (right side surface) of end wall 221. Outer part 313 covers at least a portion near the upper end of the outer side surface of end wall 221. Outer part 313 covers substantially the entire outer side surface of end wall 221.

As illustrated in FIG. 4, outer part 313 is formed in a rectangular plate shape having a constant width dimension (dimension in second axis A2).

The upper end of outer part 313 is connected to an outer end (right end) of upper part 311. The corner connecting the upper end of outer part 313 and the outer end of upper part 311 is curved part 316.

Curved part 316 between outer part 313 and upper part 311 and curved part 315 between inner part 312 and upper part 311 are curved in the same manner. For example, curved part 316 and curved part 315 have substantially the same radius of curvature. End piece 31 is formed in an inverted U shape so as to protrude upward.

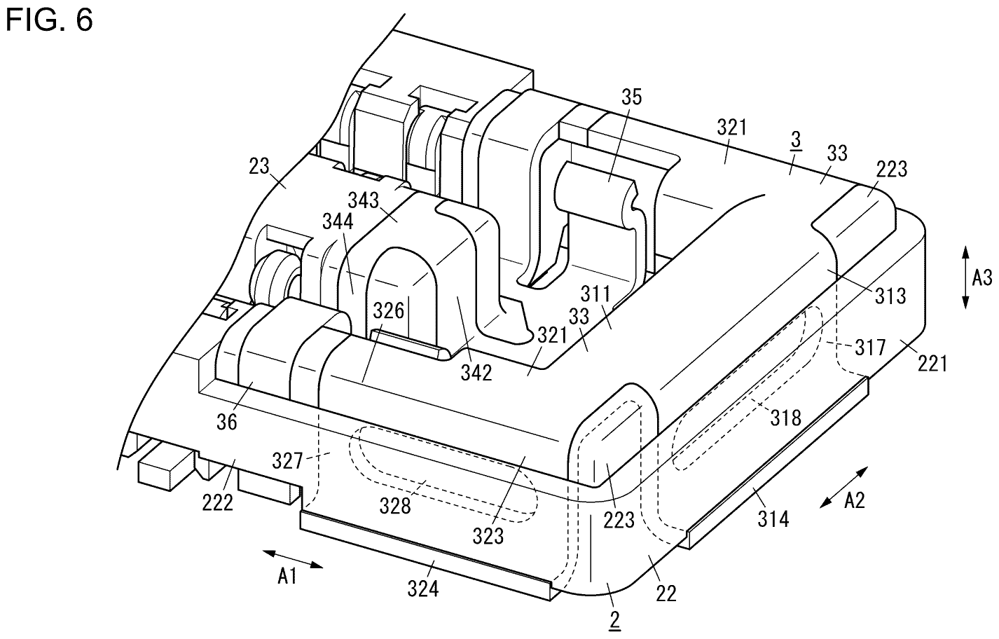

As illustrated in FIG. 6, outer part 313 of the present exemplary embodiment has buried part 317 buried in end wall 221 of peripheral wall 22. Specifically, buried part 317 is a portion from the central portion to the lower end in the direction along third axis A3 in outer part 313. According to the above configuration, the fixing strength between housing 2 and holding metal fitting 3 is improved. The upper end of outer part 313 is not buried in end wall 221 of peripheral wall 22.

As illustrated in FIG. 4, buried part 317 of outer part 313 has through hole 318. Through hole 318 is provided substantially at the center of outer part 313. Through hole 318 of the present exemplary embodiment has an elliptical shape. Through hole 318 may have a circular shape. When housing 2 is integrally insert-molded with holding metal fitting 3, the resin material of housing 2 is filled inside through hole 318, and a portion of end wall 221 located inside outer part 313 and a portion of end wall 221 located outside outer part 313 are connected via the resin material inside through hole 318. This improves adhesiveness between housing 2 and holding metal fitting 3.

End piece 31 further includes terminal part 314. Terminal part 314 has a rectangular plate shape having the same width dimension as the width dimension of outer part 313, and extends outward along first axis A1 from the lower end of outer part 313.

The lower surface of terminal part 314 is a joint surface to be joined to first substrate 91 by soldering, for example. In this manner, end piece 31 further includes an end-side fixing part (terminal part 314; hereinafter, also referred to as “first-end-side fixing part”) fixed to first substrate 91 (circuit board). Since the tip of terminal part 314 protrudes outward with respect to outer part 313, there is an advantage that it is easy to check whether soldering of terminal part 314 to first substrate 91 is performed.

### Side Piece

Two side pieces 32 are provided at both ends (front end and rear end) of end piece 31 in second axis A2. As illustrated in FIGS. 3 and 4, end piece 31 and two side pieces 32 are connected in an inverted C shape in plan view.

One (front side) side piece 32 protects an end on one side (right side) of one (front side) side wall 222 of housing 2 in first axis A1. The other (rear side) side piece 32 protects an end on one side (right side) of the other (rear side) side wall 222 of housing 2 in first axis A1.

Each of two side pieces 32 has upper part 321, inner part 322, and outer part 323.

Upper part 321 is disposed on the upper side of the end on one side (right side) of side wall 222 and covers at least a part of an upper surface on one side (right side) of side wall 222. Upper part 321 covers substantially the entire upper surface (portion other than corner 223) on one side (right side) of side wall 222.

Inner part 322 is disposed inside the end on one side (right side) of side wall 222 and covers at least a part of an inner side surface on one side (right side) of side wall 222. Inner part 322 covers at least a portion near the upper end of the inner side surface on one side (right side) of side wall 222. The inner side surface of inner part 322 is exposed to first fitting recess 24. The inner surface of inner part 322 is connected to an exposed surface of the inner side surface of side wall 222 that is not covered with inner part 322 without a step.

As illustrated in FIG. 3, inner part 322 has a rectangular plate-like portion having a constant width dimension (dimension in first axis A1).

The upper end of inner part 322 is connected to an inner end of upper part 321. The corner connecting the upper end of inner part 322 and the inner end of upper part 321 is curved part 325.

As illustrated in FIG. 3, side piece 32 further includes cutout 329. Cutout 329 is formed in the entire inner part 322 in the directions (up-down directions) along third axis A3. More specifically, cutout 329 is formed at the left end of inner part 322. Cutout 329 of the present exemplary embodiment is formed across upper part 321, curved part 325, and inner part 322.

Outer part 323 is disposed outside an end on one side (right side) of side wall 222 and covers at least a part of an outer side surface on one side (right side) of side wall 222. Outer part 323 covers at least a portion near the upper end of the outer side surface on one side (right side) of side wall 222.

As illustrated in FIGS. 3 and 4, outer part 323 is formed in a rectangular plate shape having a constant width dimension (dimension in first axis A1).

The upper end of outer part 323 is connected to an outer end of upper part 321. The corner connecting the upper end of outer part 323 and the outer end of upper part 321 is curved part 326.

Curved part 326 between outer part 323 and upper part 321 and curved part 325 between inner part 322 and upper part 321 are curved in the same manner. For example, curved part 326 and curved part 325 have substantially the same radius of curvature. Side piece 32 is formed in an inverted U shape so as to protrude upward.

As illustrated in FIG. 6, outer part 323 of the present exemplary embodiment has buried part 327 buried in side wall 222 of peripheral wall 22. Specifically, buried part 327 is a portion from the central portion to the lower end in the directions along third axis A3 in outer part 323. According to the above configuration, the fixing strength between housing 2 and holding metal fitting 3 is improved. The upper end of outer part 323 is not buried in end wall 221 of peripheral wall 22.

As illustrated in FIGS. 3 and 4, buried part 327 of outer part 323 has through hole 328. Through hole 328 is provided substantially at the center of outer part 323. Through hole 328 of the present exemplary embodiment has an elliptical shape. Through hole 328 may have a circular shape. When housing 2 is insert-molded integrally with holding metal fitting 3, the resin material of housing 2 is filled inside through hole 328, and a portion of side wall 222 located inside outer part 323 and a portion of side wall 222 located outside outer part 323 are connected via the resin material inside through hole 328. This improves adhesiveness between housing 2 and holding metal fitting 3.

Side piece 32 further includes terminal part 324. Terminal part 324 has a rectangular plate shape having the same width dimension as the width dimension of outer part 323, and extends outward along second axis A2 from the lower end of outer part 323. The lower surface of terminal part 324 is a joint surface to be joined to first substrate 91 by soldering, for example. In this manner, side piece 32 includes the side-part-side fixing part (terminal part 324; hereinafter, also referred to as “first-side-part-side fixing part”) fixed to first substrate 91 (circuit board). Since the tip of terminal part 324 protrudes outward with respect to outer part 323, there is an advantage that it is easy to check whether soldering of terminal part 324 to first substrate 91 is performed.

### Coupling Part

Coupling part 33 connects end piece 31 and side piece 32. One (front side) coupling part 33 of two coupling parts 33 connects the front end of end piece 31 and the right end of side piece 32 on the front side. The other (rear side) coupling part 33 of two coupling parts 33 connects the rear end of end piece 31 and the right end of side piece 32 on the rear side.

Coupling part 33 includes upper coupling part 331 and inner coupling part 332. Upper coupling part 331 connects upper part 311 of end piece 31 and upper part 321 of side piece 32 without discontinuities at corner 223 of peripheral wall 22. Inner coupling part 332 connects inner part 312 of end piece 31 and inner part 322 of side piece 32 without discontinuities at corner 223 of peripheral wall 22. Thus, coupling part 33 connects curved part 315 of end piece 31 and curved part 325 of side piece 32 without discontinuities. In the present disclosure, “connect without discontinuities” is preferably continuous without discontinuities, but is not limited to having no discontinuities in a strict sense between two parts to be connected. For example, a hole inevitably generated at the time of manufacturing, a minute hole formed after manufacturing, or the like may be present at the joint portion.

Upper coupling part 331 has a lower surface adjacent to peripheral wall 22 and an upper surface away from peripheral wall 22 in one section along third axis A3. The upper surface of upper coupling part 331 connects the upper surface of upper part 311 of end piece 31 and the upper surface of upper part 321 of side piece 32. Lower surface of upper coupling part 331 connects the lower surface of upper part 311 of end piece 31 and the lower surface of upper part 321 of side piece 32.

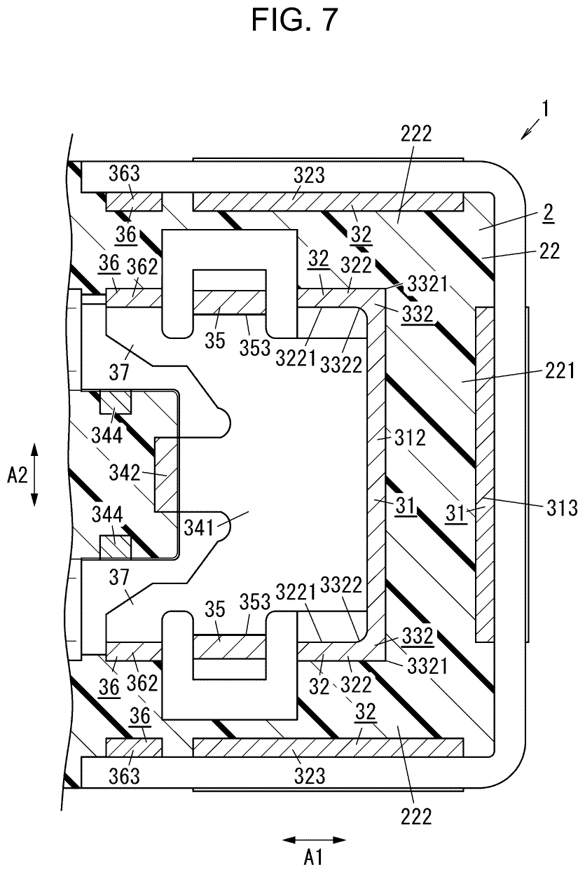

As illustrated in FIG. 7, inner coupling part 332 has outer surface 3321 adjacent to peripheral wall 22 and inner surface 3322 away from peripheral wall 22 with respect to outer surface 3321 in one section orthogonal to third axis A3. Outer surface 3321 and inner surface 3322 of inner coupling part 332 are curved so as to protrude outward with respect to the center of connector 1. In the present disclosure, “the outer surface (or the inner surface) of the coupling part is curved so as to protrude outward” means that the outer surface (or the inner surface) of the coupling part is connected without interruption in one section orthogonal to third axis A3, and a portion between any two points in the outer surface (or the inner surface) of the coupling part is outside a line segment connecting the two points. In a specific example in which outer surface 3321 (or inner surface 3322) of inner coupling part 332 has an arc shape in one section orthogonal to third axis A3, the center of the arc is on the inner side with respect to inner coupling part 332.

Inner part 312 of end piece 31 and inner part 322 of side piece 32 are connected to each other without discontinuities along third axis A3 by inner coupling part 332. Inner coupling part 332 connects the lower end of inner part 312 of end piece 31 at one end (front end or rear end) in second axis A2 and the lower end of inner part 322 of side piece 32 at one end (right end) in first axis A1 without a step.

In the present exemplary embodiment, as illustrated in FIG. 4, holding metal fitting 3 has slit 333 formed between outer part 313 of end piece 31 and outer part 323 of side piece 32. Slit 333 extends along third axis A3. Thus, in holding metal fitting 3, outer part 313 of end piece 31 and outer part 323 of side piece 32 are not connected, and curved part 316 of end piece 31 and curved part 326 of side piece 32 are not connected.

The portion of slit 333 of holding metal fitting 3 is filled with a portion of corner 223 of peripheral wall 22 (see FIG. 6).

### Intermediate Extension

As illustrated in FIGS. 3 to 5, intermediate extension 34 includes bottom 341, rising part 342, upper end 343, and two falling parts 344.

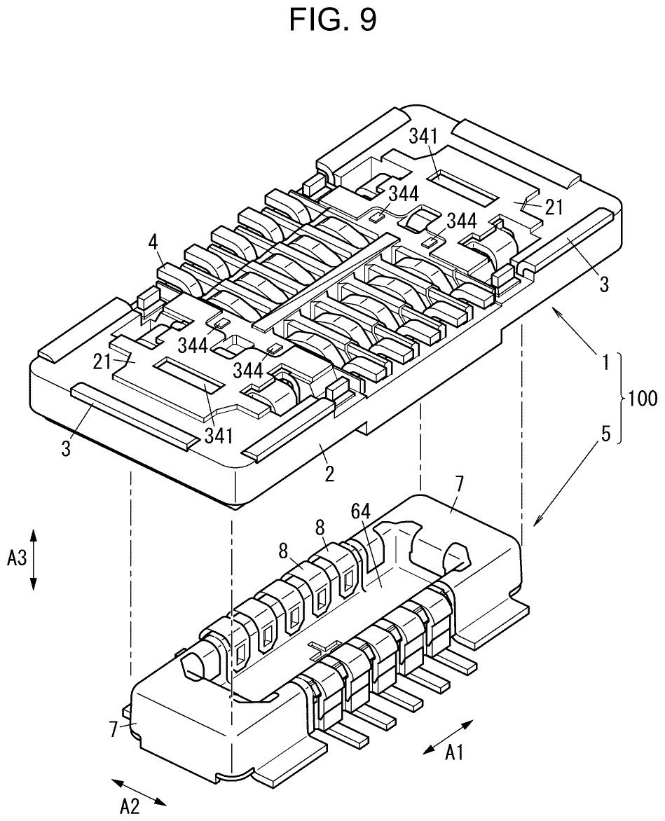

Bottom 341 has a substantially rectangular plate shape extending along first axis A1. In the present exemplary embodiment, the first end (right end) of bottom 341 is connected to the lower end of inner part 312 of end piece 31. In other words, bottom 341 of the present exemplary embodiment extends from the lower end of inner part 312 of end piece 31. This has an advantage that bottom 341 is easily formed. The corner connecting the first end of bottom 341 and the lower end of inner part 312 is curved. Bottom 341 is located between the pair of side walls 222 of housing 2 in second axis A2. Bottom 341 extends along bottom wall 21 of housing 2. As illustrated in FIG. 9, a part of bottom 341 is exposed to the lower surface of bottom wall 21 (surface facing first substrate 91).

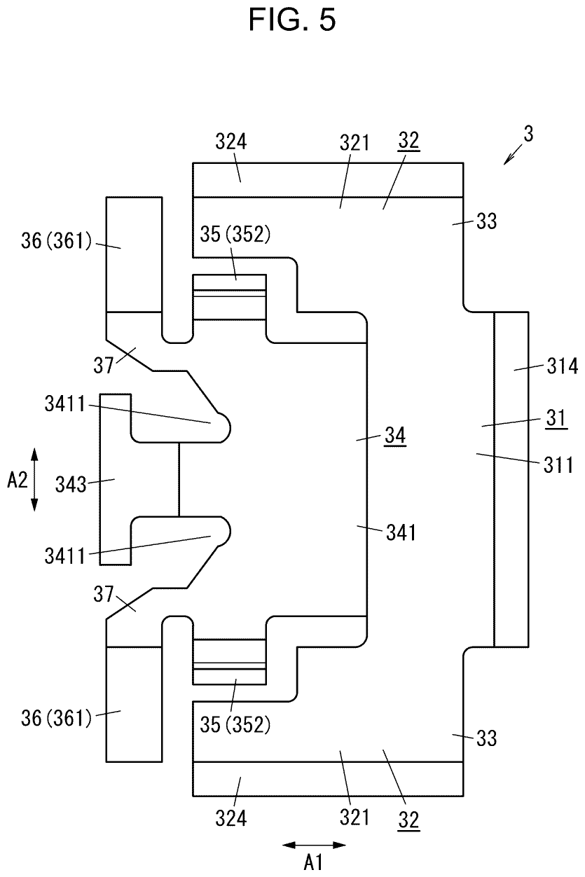

In the present exemplary embodiment, the width dimension (dimension in second axis A2) of bottom 341 is the same as the width dimension of the second part of inner part 312. Specifically, as illustrated in FIG. 5, the shape of bottom 341 is a rectangular plate shape in which two cutouts 3411 are provided at the second end (left end). Cutout 3411 has a substantially triangular shape in plan view of holding metal fitting 3.

As illustrated in FIGS. 3 and 4, rising part 342 has a rectangular plate shape extending upward from the second end (left end) of bottom 341. The lower end of rising part 342 is connected to the portion between two cutouts 3411 at the second end of bottom 341. The corner connecting the lower end of rising part 342 and the second end of bottom 341 is curved.

Since holding metal fitting 3 has bottom 341, it is possible to protect bottom wall 21 of housing 2, and there is an advantage that bottom wall 21 is less likely to be damaged at the time of fitting.

As illustrated in FIG. 6, rising part 342 extends along the side surface of the end (right end) of intermediate base 23. Rising part 342 extends along the side surface of the end of intermediate base 23 and covers at least a part of the side surface of the end of intermediate base 23. The outer surface of rising part 342 (the surface connected to the upper surface of bottom 341) is exposed to first fitting recess 24. The outer surface of rising part 342 is connected to the exposed surface, which is not covered with rising part 342, of the side surface of the end of intermediate base 23 without a step.

As illustrated in FIGS. 3 and 4, upper end 343 has a rectangular plate shape extending leftward along first axis A1 from the upper end of rising part 342. The first end (right end) of upper end 343 is connected to the upper end of rising part 342. The corner connecting the first end of upper end 343 and the upper end of rising part 342 is curved.

As illustrated in FIG. 6, upper end 343 extends along the upper part of the end of intermediate base 23. Upper end 343 is disposed on the upper side of intermediate base 23 of housing 2 and covers at least a part of the upper surface of the end (right end) of intermediate base 23. The upper surface of upper end 343 is connected to an exposed surface, which is not covered with upper end 343, of the upper surface of the end of intermediate base 23 without a step.

As illustrated in FIGS. 3 and 4, each of two falling parts 344 has a rectangular plate shape extending downward from upper end 343. Falling part 344 of one (front side) of two falling parts 344 extends downward from the front end of upper end 343. The upper end of falling part 344 on the front side is connected to the front end of upper end 343. In the same manner, the other (rear side) falling part 344 of two falling parts 344 extends downward from the rear end of upper end 343. The upper end of falling part 344 on the rear side is connected to the rear end of upper end 343. The corner connecting the upper end of falling part 344 on the front side and the front end of upper end 343 is curved, and a corner connecting the upper end of falling part 344 on the rear side and the rear end of upper end 343 is also curved.

As illustrated in FIG. 6, each of two falling parts 344 is along the side surface of the end (front end and rear end) of intermediate base 23. Each of two falling parts 344 extends along the side surface of the end of intermediate base 23 and covers at least a part of the side surface of the end of intermediate base 23. The outer surface of each of two falling parts 344 is exposed to first fitting recess 24. The outer surface of each of two falling parts 344 is connected to the exposed surface, which is not covered with two falling parts 344, of the side surfaces of the end of the intermediate base 23 without a step. The lower end of falling part 344 is accommodated in bottom wall 21. As illustrated in FIG. 9, the lower end of falling part 344 is exposed to the lower surface of bottom wall 21.

Since holding metal fitting 3 has rising part 342, upper end 343, and two falling parts 344, it is possible to protect intermediate base 23 of housing 2, and there is an advantage that intermediate base 23 is less likely to be damaged at the time of fitting.

### Side Extension Piece

As illustrated in FIG. 3, each of two side extension pieces 36 is provided on the side (left side) opposite to end piece 31 in first axis A1 with respect to two side pieces 32.

More specifically, one (front side) side extension piece 36 is provided on the opposite side (left side) to end piece 31 in first axis A1 with respect to one (front side) side piece 32, and is arranged with one (front side) side piece 32 along first axis A1. In the same manner, the other (rear side) side extension piece 36 is provided on the opposite side (left side) to end piece 31 in first axis A1 with respect to the other (rear side) side part piece 32, and is arranged with the other (rear side) side piece 32 along first axis A1.

Hereinafter, in principle, side extension piece 36 on the front side will be described as an example, and side extension piece 36 on the rear side has the same structure.

As illustrated in FIGS. 3 and 4, side extension piece 36 includes upper part 361, inner part 362, and outer part 363. Each of upper part 361, inner part 362, and outer part 363 is formed in a rectangular plate shape having a constant width dimension (dimension in first axis A1). The width dimensions of upper part 361, inner part 362, and outer part 363 are the same. Side extension piece 36 is formed in an inverted U shape so as to protrude upward.

Upper part 361 is disposed on the upper side of one (front side) side wall 222, and is located on the second end side (left side) in first axis A1 with respect to upper part 321 of one (front side) side piece 32. Upper part 361 covers at least a part of the upper surface on the first end side (right side) of one (front side) side wall 222. Upper part 361 covers a portion located closer to the second end side (left side) than the portion covered by upper part 321 of one (front side) side piece 32 on the upper surface of side wall 222 on first end side (right side).

Inner part 362 is disposed inside the one (front side) side wall 222, and is located on the second end side (left side) in first axis A1 with respect to inner part 322 of one (front side) side piece 32. Inner part 362 covers at least a part of the inner side surface on the first end side (right side) of one (front side) side wall 222. Inner part 362 covers a portion located closer to the second end side (left side) than the portion covered by inner part 322 of one (front side) side piece 32 on the inner side surface on the first end side (right side) of one (front side) side wall 222.

The inner side surface of inner part 362 is exposed to first fitting recess 24. The inner surface of inner part 362 is located inside an exposed surface of the inner side surface of side wall 222 that is not covered with the inner part. The side surface on the first end side (right side) of inner part 362 is substantially flush with a side surface on the second end side (left side) of spring storage 28 of housing 2.

The upper end of inner part 362 is connected to an inner end of upper part 361. The corner connecting the upper end of inner part 362 and the inner end of upper part 361 is curved part 365.

In the present exemplary embodiment, the lower end of inner part 362 is coupled to bottom 341 of intermediate extension 34 via bottom extension 37. In other words, bottom extension 37 couples bottom 341 of intermediate extension 34 and inner part 362 of side extension piece 36. In the present exemplary embodiment, the right end of side extension piece 36 is not coupled to the left end of side piece 32.

The bottom extension 37 has a plate shape extending along first axis A1. Bottom extension 37 is along bottom wall 21 of housing 2.

As illustrated in FIG. 5, bottom extension 37 can be regarded as a portion where the second end (left end) of bottom 341 extends toward the lower end of inner part 362. In bottom extension 37 of the present exemplary embodiment, a portion closer to one end (front end) than cutout 3411 on one side (front side) at the second end (left end) of bottom 341 can be regarded as a portion extending toward the lower end of inner part 362.

Outer part 363 is disposed outside one (front side) side wall 222, and is located on the second end side (left side) in first axis A1 with respect to outer part 323 of one (front side) side piece 32. Outer part 363 covers at least a part of the outer side surface on the first end side (right side) of one (front side) side wall 222. Outer part 363 covers a portion located closer to the second end side (left side) than the portion covered by outer part 323 of one (front side) side piece 32 on the outer side surface on the first end side (right side) of one (front side) side wall 222.

The upper end of outer part 363 is connected to an outer end of upper part 361. The corner connecting the upper end of outer part 363 and the outer end of upper part 361 is curved part 366.

Curved part 366 between outer part 363 and upper part 361 is curved more steeply than curved part 365 between inner part 362 and upper part 361. For example, in terms of the radius of curvature, curved part 366 is smaller than curved part 365.

From the above, one (front side) side extension piece 36 can be regarded as a portion in which one (front side) side piece 32 is extended toward the side (left side) opposite to end piece 31 along first axis A1.

### Spring Piece

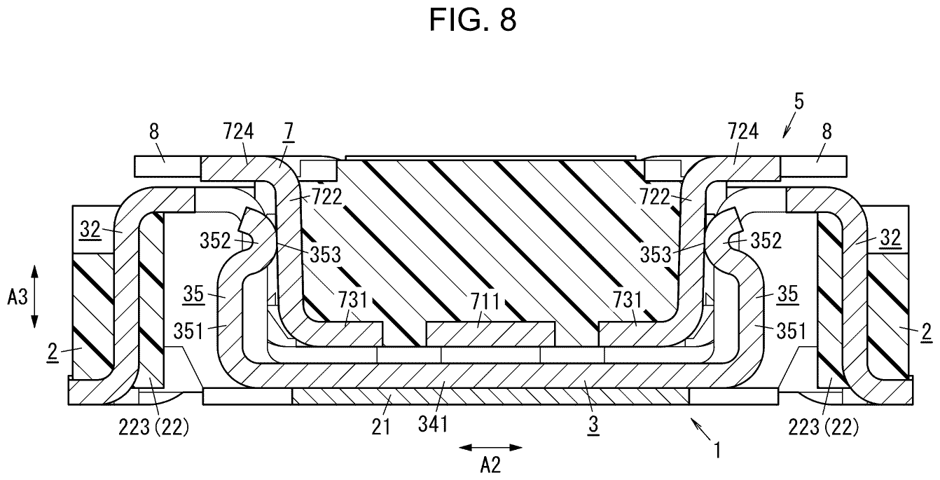

As illustrated in FIGS. 3 and 8, two spring pieces 35 extend upward from bottom 341 and are configured to be elastically deformable outward along second axis A2. Each of two spring pieces 35 is pressed by a corresponding mating holding metal fitting 7 (described later) of mating connector 5 in a state where mating connector 5 is connected to connector 1. Consequently, each of two spring pieces 35 generates an elastic force in a direction (inward) toward corresponding mating holding metal fitting 7. The “elastic force” herein acts as a contact pressure applied to mating connector 5 by connector 1 in a state where mating connector 5 is connected to connector 1.

As illustrated in FIG. 8, each of two spring pieces 35 has rising part 351 and tip part 352.

As illustrated in FIG. 3, rising part 351 is a plate member extending upward from both ends (front end and rear end) of bottom 341 in second axis A2. Rising part 351 of spring piece 35 on the front side of two spring pieces 35 extends upward from the front end of bottom 341, and the lower end of rising part 351 is connected to the front end of bottom 341. The corner connecting the lower end of rising part 351 of spring piece 35 on the front side of two spring pieces 35 and the front end of bottom 341 is curved.

In the same manner, rising part 351 of spring piece 35 on the rear side of two spring pieces 35 extends upward from the rear end of bottom 341 in second axis A2, and the lower end of rising part 351 is connected to the rear end of bottom 341. The corner connecting the lower end of rising part 351 of spring piece 35 on the rear side of two spring pieces 35 and the rear end of bottom 341 is curved.

As illustrated in FIG. 8, tip part 352 is a plate member curved so as to form protrusion 353 protruding inward. The lower end of tip part 352 of spring piece 35 on the front side of two spring pieces 35 is connected to the upper end of rising part 351 of spring piece 35. In the same manner, the lower end of tip part 352 of spring piece 35 on the rear side of two spring pieces 35 is connected to the upper end of rising part 351 of spring piece 35.

As illustrated in FIG. 7, the inner tip of protrusion 353 in spring piece 35 on the front side is located inside with respect to inner surface 3221 of inner part 322 of side piece 32 on the front side. In the same manner, the inner tip of protrusion 353 in spring piece 35 on the rear side is located inside with respect to inner surface 3221 of inner part 322 of side piece 32 on the rear side. According to this configuration, two spring pieces 35 of holding metal fitting 3 are pushed outward along second axis A2 by mating holding metal fitting 7 and elastically deformed in a state where mating connector 5 is connected to connector 1. As a result, two spring pieces 35 of holding metal fitting 3 generate elastic force in a direction (inward) toward mating holding metal fitting 7 and come into contact with mating holding metal fitting 7.

Protrusion 353 is located near the upper ends of inner part 312 of end piece 31 and inner part 362 of side extension piece 36 in third axis A3. Protrusion 353 is located at substantially the same position as inner part 322 of side piece 32 in third axis A3. The upper end of tip part 352 is located at substantially the same position as curved part 315 of end piece 31, curved part 325 of side piece 32, and curved part 365 of side extension piece 36 in third axis A3. That is, protrusion 353 and tip part 352 of two spring pieces 35 are provided relatively above fitting recess 24 (see FIG. 1). Thus, there is an advantage that two spring pieces 35 can ensure elastic force (contact pressure) in a state where mating connector 5 is connected to connector 1.

As illustrated in FIG. 7, each of two spring pieces 35 is disposed between inner part 322 of side piece 32 and inner part 362 of side extension piece 36 in first axis A1. More specifically, each of two spring pieces 35 is disposed so as to be accommodated in cutout 329 located between inner part 322 of side piece 32 and inner part 362 of side extension piece 36 in first axis A1. According to this configuration, there is an advantage that inner part 322 of side piece 32 and inner part 362 of side extension piece 36 can protect spring piece 35, and spring piece 35 is less likely to be damaged.

In connector 1 of the present exemplary embodiment, the first-end-side fixing part and the first-side-part-side fixing part of holding metal fitting 3 on the first side (right side) in first axis A1 are connected to the conductor of first substrate 91. Similarly, the first-end-side fixing part and the first-side-part-side fixing part of holding metal fitting 3 on the second side (left side) in first axis A1 are connected to the conductor of first substrate 91. Two spring pieces 35 of holding metal fitting 3 function as power supply terminals for transmitting power to mating connector 5 (mating holding metal fitting) in a state where mating connector 5 is connected to connector 1.

### (2-2) Header

Next, mating connector 5 as a header will be described with reference to FIGS. 9 to 12.

Mating connector 5 is formed in a flat rectangular box shape having a length along first axis A1, a width along second axis A2 intersecting (here, orthogonal to) second axis A2, and a height along third axis A3 intersecting (here, orthogonal to) both first axis A1 and second axis A2. Connector 1 is fitted to mating connector 5 along third axis A3.

In the column of “(2-2) Header”, for convenience of description, one side and the other side in first axis A1 are respectively referred to as “left” and “right”, one side and the other side in second axis A2 are respectively referred to as “front” and “rear”, and one side and the other side in third axis A3 are respectively referred to as “up” and “down”. In particular, when mating connector 5 and connector 1 are fitted to each other, the side on which mating connector 5 is located in third axis A3 is referred to as “down”, and the side on which connector 1 is located is referred to as “up”. That is, in the column of “(2-2) Header”, the top and bottom in the column of “(2-1) Socket” are reversed. The above definition of the directions is not intended to limit the use form of mating connector 5.

In the column of “(2-2) Header”, in plan view of mating connector 5, a side close to the center of mating connector 5 is referred to as “inner side”, and a side far from the center of mating connector 5 is referred to as “outer side”. That is, the “outer side” refers to a side away from the center with the center of mating connector 5 as a reference (inner side).

The length dimension (dimension in first axis A1) of mating connector 5 is, for example, several mm to several tens of mm. The width dimension (dimension in second axis A2) of mating connector 5 is, for example, several mm. The height dimension (dimension in third axis A3) of mating connector 5 is, for example, a comma several mm.

As illustrated in FIG. 9, mating connector 5 includes mating housing 6, a pair of mating holding metal fittings 7, and a plurality of mating terminals 8.

### (2-2-1) Housing, Terminal

Mating housing 6 is a resin molded body having an insulating property. In the present exemplary embodiment, mating housing 6 is an insert-molded article including a pair of mating holding fittings 7 and a plurality of mating terminals 8 as insert articles.

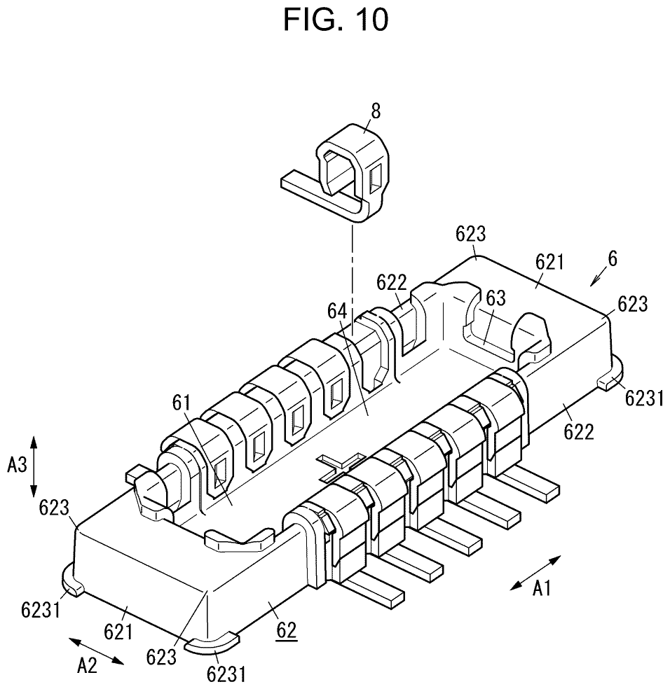

Mating housing 6 has a flat rectangular parallelepiped shape having a length along first axis A1. As illustrated in FIG. 10, mating housing 6 includes mating bottom wall 61 and mating peripheral wall 62. Mating bottom wall 61 and mating peripheral wall 62 are integrally formed. Mating bottom wall 61 has a plate shape elongated along first axis A1 and constitutes the bottom of mating housing 6. Mating peripheral wall 62 protrudes upward from the peripheral edge of mating bottom wall 61 and has a rectangular frame shape in plan view. That is, mating peripheral wall 62 is formed so as to surround the center along the peripheral edge of mating bottom wall 61.

Mating peripheral wall 62 has a pair of mating end walls 621 and a pair of mating side walls 622. The pair of mating end walls 621 extends along second axis A2 and faces each other along first axis A1. The pair of mating side walls 622 is positioned at both ends of the pair of mating end walls 621 in second axis A2. The pair of mating side walls 622 extends along first axis A1 and faces each other along second axis A2.

Mating peripheral wall 62 has a total of four corners 623 at positions where mating end wall 621 and mating side wall 622 are connected. Protrusions 6231 protruding outward are provided at lower ends of four corners 623.

The portion surrounded by mating bottom wall 61 and mating peripheral wall 62 forms a fitting recess (hereinafter, also referred to as “second fitting recess”) 64 into which connector 1 is fitted. Specifically, intermediate base 23 of connector 1 is fitted into second fitting recess 64. Consequently, connector 1 is connected to mating connector 5.

Stepped part 63 is formed between mating bottom wall 61 and mating end wall 621 of mating peripheral wall 62.

Each of the pair of mating side walls 622 of mating peripheral wall 62 is provided with half of a plurality of mating terminals 8. Specifically, the pair of mating side walls 622 holds a total of 10 mating terminals 8, that is, 5 mating terminals 8 for each.

The interval at which the plurality of mating terminals 8 are arranged, that is, the pitch is, for example, a comma several mm. The pitch of the plurality of mating terminals 8 is substantially equal to the pitch of the plurality of terminals 4. In the present exemplary embodiment, the plurality of mating terminals 8 is arranged at equal pitches, but they may be arranged at irregular pitches.

Mating terminal 8 (terminal of mating connector 5) is a metal molded body made of a metallic material such as a copper alloy. Mating terminal 8 is plated with gold, but is not limited thereto, and it does not have to be plated with gold.

As illustrated in FIG. 13, mating terminal 8 includes contact piece 81, hanging piece 82, and terminal piece 83, which are integrally formed.

Contact piece 81 has a plate shape. Contact piece 81 is provided on a surface of mating side wall 622 facing second fitting recess 64. Contact piece 81 is exposed to second fitting recess 64. Contact piece 81 comes into contact with corresponding terminal 4 in a state where connector 1 is connected to mating connector 5.

Contact piece 81 is provided with depression 811 depressed in a direction away from second fitting recess 64. Depression 811 is configured such that a part (curved piece 44) of corresponding terminal 4 is fitted in a state where connector 1 is connected to mating connector 5. That is, depression 811 of contact piece 81 and corresponding terminal 4 constitute a lock mechanism capable of preventing mating connector 5 from being detached from connector 1 and releasing connection state between connector 1 and mating connector 5 by applying a predetermined or stronger force.

Hanging piece 82 has a plate shape. Hanging piece 82 is provided along the outer surface of mating side wall 622. The first end (upper end) of hanging piece 82 is curved in an inverted U shape and is integrated with the first end (upper end) of contact piece 81.

Hanging piece 82 is integrated with projection 821 protruding along the thickness axis of hanging piece 82. Projection 821 is arranged along third axis A3 with projection 451 of corresponding terminal 4 of connector 1 in a state where connector 1 is connected to mating connector 5, and is located on the bottom side of terminal 4 with respect to projection 451. Thus, unless mating connector 5 is tried to be pulled out from connector 1 with a predetermined or stronger force, projection 451 of terminal 4 is caught by projection 821 of mating terminal 8, and thus the connection state between connector 1 and mating connector 5 is not released. That is, projection 821 of mating terminal 8 and projection 451 of terminal 4 constitute a lock mechanism capable of preventing mating connector 5 from being detached from connector 1 and releasing the connection state between mating connector 5 and connector 1 by applying a predetermined or stronger force.

Terminal piece 83 has a plate shape. The first end (inner end) of terminal piece 83 is integrated with the second end (lower end) of contact piece 81. The second end of terminal piece 83 is exposed from mating housing 6 on one end side (lower side) in third axis A3. The lower surface of terminal piece 83 is a joint surface to be joined to second substrate 92 by soldering, for example.

All of the plurality (10) of mating terminals 8 are signal terminals. Five mating terminals 8 (signal terminals) are provided on each of the pair of mating side walls 622 in a state of being arranged along first axis A1.

Each of the plurality of mating terminals 8 is partially exposed to second fitting recess 64 in a state of being held by mating side wall 622. Specifically, a part of contact piece 81 of each of the plurality of mating terminals 8 is exposed to second fitting recess 64. In each of the plurality of mating terminals 8, a part of hanging piece 82 is exposed to the outer side surface side of mating side wall 622.

When mating connector 5 is connected to connector 1, in each of the plurality of mating terminals 8, a portion (contact piece 81) exposed in second fitting recess 64 comes into contact with curved piece 44 of terminal 4 of connector 1. In each of the plurality of mating terminals 8, hanging piece 82 comes into contact with rising piece 45 of terminal 4 of connector 1 (terminal 4). Consequently, each of the plurality of mating terminals 8 of mating connector 5 is electrically connected to corresponding terminal 4 of connector 1.

### (2-2-2) Holding Metal Fitting

Mating holding metal fitting 7 is a metal molded body made of a metallic material such as a copper alloy, for example. Mating holding metal fitting 7 is used to improve the strength of mating connector 5.

As illustrated in FIG. 9, on mating peripheral wall 62 of the present exemplary embodiment, one (two in total) mating holding metal fitting 7 is disposed at each of both ends (left end and right end) in first axis A1. Mating holding metal fitting 7 may be disposed at one end (left end or right end) of mating peripheral wall 62 in first axis A1.

Hereinafter, in principle, mating holding metal fitting 7 attached to the right end of mating housing 6 will be described as an example, and mating holding metal fitting 7 attached to the left end of mating housing 6 has the same structure.

Mating holding metal fitting 7 is integrally formed seamlessly (without any joint) by, for example, drawing.

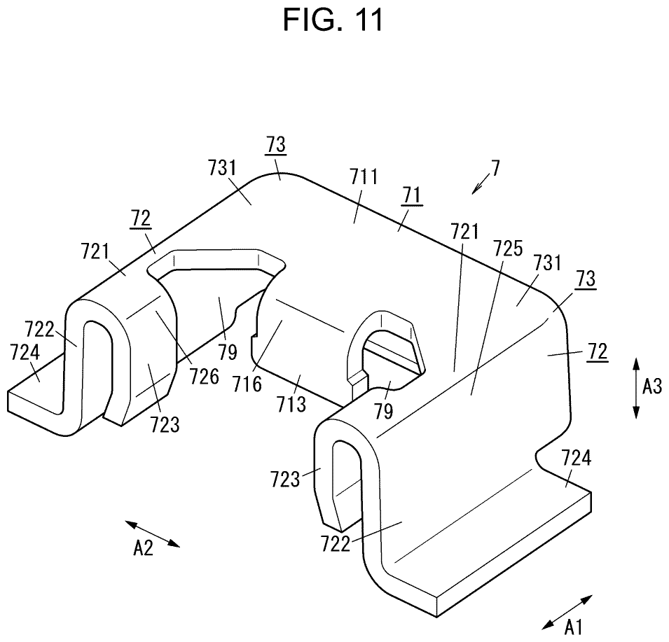

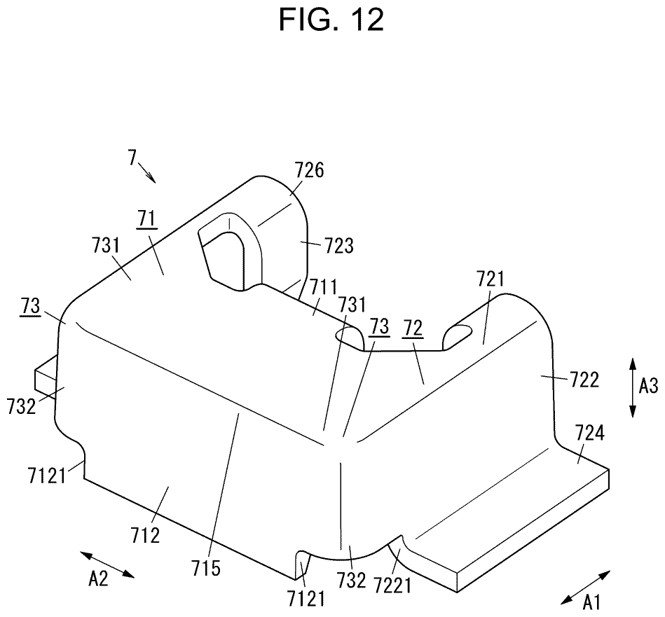

As illustrated in FIGS. 11 and 12, mating holding metal fitting 7 includes mating end piece 71, mating side piece 72, and mating coupling part 73. Specifically, mating holding metal fitting 7 includes one mating end piece 71, two mating side pieces 72, and two mating coupling part 73.

### End Piece

Mating end piece 71 protects one (right) mating end wall 621 of mating housing 6. Mating end piece 71 includes upper part 711, outer part 712, and inner part 713.

Upper part 711 is disposed on the upper side of mating end wall 621 and covers at least a part of the upper surface of mating end wall 621. Upper part 711 covers at least a portion on the outer side (right side) in first axis A1 in the upper surface of mating end wall 621.

Inner part 713 is disposed on the inner side (left side) of mating end wall 621 and covers at least a part of the inner side surface (left side surface) of mating end wall 621.

Inner part 713 covers a central portion in second axis A2 in the inner side surface of mating end wall 621.

The upper end of inner part 713 is connected to an inner end (left end) of upper part 711. The corner connecting the upper end of inner part 713 and the inner end of upper part 711 is curved part 716.

As illustrated in FIG. 11, inner part 713 has a rectangular plate-like portion having a constant width dimension (dimension in second axis A2). The width dimension (dimension in second axis A2) of inner part 713 is smaller than the width dimension of upper part 711. The inner side surface (left side surface) of inner part 713 is exposed to second fitting recess 64. The inner side surface of inner part 713 is connected to a portion of the inner side surface of mating end wall 621 adjacent to the inner part 713 in second axis A2 without a step.

Inner part 713 comes into contact with intermediate extension 34 (specifically, rising part 342) of holding metal fitting 3 of connector 1 in a state where connector 1 is connected to mating connector 5.

Outer part 712 is disposed outside (right side) mating end wall 621 and covers at least a part of the outer side surface (right side surface) of mating end wall 621. Outer part 712 covers at least a portion near the upper end of the outer side surface of mating end wall 621. Outer part 712 covers substantially the entire outer side surface of mating end wall 621.

As illustrated in FIG. 11, outer part 712 is formed in a rectangular plate shape having a constant width dimension (dimension in second axis A2). Both side portions in second axis A2 at the lower end of outer part 712 are recessed parts 7121 recessed upward.

The lower surface of outer part 712 is a joint surface to be joined to second substrate 92 by soldering, for example. In this manner, mating end piece 71 has the end-side fixing part (lower end of outer part 712; hereinafter, also referred to as “second-end-side fixing part”) fixed to second substrate 92 (circuit board).

The lower end of outer part 712 of mating end piece 71 is inclined on the inner side surface side so as to have a tapered shape that becomes thinner toward the lower end side.

The upper end of outer part 712 is connected to an outer end (right end) of upper part 711. The corner connecting the upper end of outer part 712 and the outer end of upper part 711 is curved part 715.

Curved part 715 between outer part 712 and upper part 711 and curved part 716 between inner part 713 and upper part 711 are curved in the same manner. For example, curved part 715 and curved part 716 have substantially the same radius of curvature.

### Side Piece

As illustrated in FIG. 11, two mating side pieces 72 are provided at both ends (front end and rear end) of mating end piece 71 in second axis A2. Mating end piece 71 and two mating side pieces 72 are connected in an inverted C shape in plan view.

One (front side) mating side piece 72 protects an end on one side (right side) of one (front side) mating side wall 622 of mating housing 6 in first axis A1. The other (rear side) mating side piece 72 protects an end on one side (right side) of the other (rear side) mating side wall 622 of mating housing 6 in first axis A1.

Each of two mating side pieces 72 has upper part 721, outer part 722, and inner part 723.

Upper part 721 is disposed on the upper side of the end on one side (right side) of mating side wall 622 and covers at least a part of the upper surface on one side (right side) of mating side wall 622. Upper part 721 covers at least an outer portion of the upper surface on one side (right side) of mating side wall 622.

Inner part 723 is disposed inside an end on one side (right side) of mating side wall 622 and covers at least a part of an inner side surface on one side (right side) of mating side wall 622. Inner part 723 covers at least a portion near the upper end of the inner side surface on one side (right side) of mating side wall 622.

The upper end of inner part 723 is connected to an inner end of upper part 721. The corner connecting the upper end of inner part 723 and the inner end of upper part 721 is curved part 726.

As illustrated in FIG. 11, inner part 723 has a rectangular plate-like portion having a constant width dimension (dimension in first axis A1). The width dimension (dimension in first axis A1) of inner part 723 is smaller than the width dimension of upper part 721. The inner side surface of inner part 723 is exposed to second fitting recess 64. The inner side surface of inner part 723 is connected to a portion of the inner side surface of mating side wall 622 adjacent to inner part 723 in first axis A1 without a step.

As illustrated in FIG. 11, inner part 723 has a rectangular plate-like first portion having a constant width dimension (dimension in first axis A1) at an upper end thereof.

Inner part 723 has a rectangular plate-like second portion having the same width dimension as the first portion on the lower side of the first portion. The second portion of inner part 723 extends so as to be inclined outward from the lower end of the first portion.

Outer part 722 is disposed outside an end part on one side (right side) of mating side wall 622 and covers at least a part of the outer side surface on one side (right side) of mating side wall 622. Outer part 722 covers at least a portion near the upper end of the outer side surface on one side (right side) of mating side wall 622. Outer part 722 covers substantially the entire outer side surface of mating side wall 622.

As illustrated in FIGS. 11 and 12, outer part 722 is formed in a rectangular plate shape having a constant width dimension (dimension in second axis A2). The left end portion in first axis A1 at the lower end of outer part 722 is recessed part 7221 recessed upward. Recessed part 7221 of mating end piece 71 is connected to recessed part 7121 of mating end piece 71, and projection 6231 of mating housing 6 is disposed.

The upper end of outer part 722 is connected to the outer end of upper part 721. The corner connecting the upper end of outer part 722 and the outer end of upper part 721 is curved part 725.

Curved part 725 between outer part 722 and upper part 721 and curved part 726 between inner part 723 and upper part 721 are curved in the same manner. For example, curved part 725 and curved part 726 have substantially the same radius of curvature. In the present exemplary embodiment, curved part 725 and curved part 726 are connected so as to be continuously curved.

As illustrated in FIG. 8, outer part 722 comes into contact with spring piece 35 of holding metal fitting 3 of connector 1 in a state where connector 1 is connected to mating connector 5.

Mating side piece 72 further includes terminal part 724. Terminal part 724 has a rectangular plate shape having the same width dimension as the width dimension of outer part 722, and extends outward along second axis A2 from the lower end of outer part 722. The lower surface of terminal part 724 is a joint surface to be joined to first substrate 91 by soldering, for example. In this manner, mating side piece 72 has the side-part-side fixing part (lower end of outer part 722; hereinafter, also referred to as “second-side-part-side fixing part”) fixed to second substrate 92 (circuit board). Since the tip of terminal part 724 protrudes outward with respect to outer part 722, there is an advantage that it is easy to check whether soldering of terminal part 724 to second substrate 92 is performed.

### Coupling Part

Mating coupling part 73 couples mating end piece 71 and mating side piece 72 at corner 623 of mating peripheral wall 62. One (front side) mating coupling part 73 of two mating coupling parts 73 couples the front end of mating end piece 71 and the right end of front mating side piece 72. The other (rear side) mating coupling part 73 of two mating coupling parts 73 couples the rear end of mating end piece 71 and the right end of rear mating side piece 72.

Mating coupling part 73 includes an upper coupling part 731 and outer coupling part 732. Upper coupling part 731 connects upper part 711 of mating end piece 71 and 28 upper part 721 of mating side piece 72 without discontinuities at corner 623 of mating peripheral wall 62. Outer coupling part 732 connects outer part 712 of mating end piece 71 and outer part 722 of mating side piece 72 without discontinuities at corner 623 of mating peripheral wall 62. Thus, mating coupling part 73 connects curved part 715 of mating end piece 71 and curved part 725 of mating side piece 72 without discontinuities.

Upper coupling part 731 has a lower surface adjacent to mating peripheral wall 62 and an upper surface away from mating peripheral wall 62 in one section along third axis A3. The upper surface of upper coupling part 731 connects the upper surface of upper part 711 of mating end piece 71 and the upper surface of upper part 721 of mating side piece 72. The lower surface of upper coupling part 731 connects the lower surface of upper part 711 of mating end piece 71 and the lower surface of upper part 721 of mating side piece 72.

Outer coupling part 732 has an inner surface adjacent to mating peripheral wall 62 and an outer surface away from mating peripheral wall 62 with respect to the inner surface in one section orthogonal to third axis A3. The inner surface and the outer surface of outer coupling part 732 are curved so as to protrude outward with respect to the center of mating connector 5.

In the present exemplary embodiment, as illustrated in FIGS. 11 and 12, in mating holding metal fitting 7, inner part 713 of mating end piece 71 and inner part 723 of mating side piece 72 are not connected. Curved part 716 of mating end piece 71 and curved part 726 of mating side piece 72 are not connected. That is, mating coupling part 73 has void 79 between inner part 713 of mating end piece 71 and inner part 723 of mating side piece 72. In mating peripheral wall 62 of mating housing 6, the entire inner surface and a part of the upper surface of corner 623 where mating end wall 621 and mating side wall 622 are connected are exposed through void 79 (see FIG. 9).

In mating connector 5 of the present exemplary embodiment, mating holding metal fitting 7 is connected to spring piece 35 of holding metal fitting 3 of connector 1. Specifically, outer part 722 of mating side piece 72 in mating holding metal fitting 7 of mating connector 5 is connected to spring piece 35 in holding metal fitting 3 of connector 1. That is, mating holding metal fitting 7 functions as a power supply terminal for receiving power transmitted from connector 1 in a state where mating connector 5 is connected to connector 1.

### (2-3) Connector Assembly

Connector assembly 100 includes a socket that is connector 1 and a header that is mating connector 5.

As described above, connector 1 is mounted on substrate 9 (first substrate 91) built in an electronic device such as a smartphone (see FIG. 13). Mating connector 5 is mounted on another substrate 9 (second substrate 92) also built in the electronic device (see FIG. 13).

Then, for example, as illustrated in FIG. 13, by moving mating connector 5 toward connector 1 and connecting connector 1 and mating connector 5, the first conductor of first substrate 91 and the second conductor of second substrate 92 are electrically connected. Specifically, the plurality of (here, 10) terminals 4 of connector 1 are electrically connected to the corresponding plurality of (here, 10) mating terminals 8 of mating connector 5, respectively. Curved piece 44 of terminal 4 is fitted into depression 811 of mating terminal 8. Projection 451 of terminal 4 comes into contact with hanging piece 82 across projection 821 of mating terminal 8.

Spring piece 35 of holding metal fitting 3 of connector 1 is electrically connected to outer part 722 of mating side piece 72 of mating holding metal fitting 7 of mating connector 5, whereby connector 1 is connected to mating connector 5. At this time, outer part 712 of mating end piece 31 of mating holding metal fitting 7 is positioned inside with respect to inner part 312 of end piece 71 of holding metal fitting 3, and inner part 312 and outer part 712 face each other with a gap interposed therebetween. Inner part 312 and outer part 712 may face each other in contact with each other. Outer part 722 of mating side piece 72 of mating holding metal fitting 7 is positioned inside with respect to inner part 322 of side piece 32 of holding metal fitting 3, and inner part 322 and outer part 722 face each other with a gap interposed therebetween.

The plurality of (here, four) spring pieces 35 of connector 1 are electrically connected to the corresponding plurality of (here, two) mating holding fittings 7 of mating connector 5, two each. Spring piece 35 of holding metal fitting 3 of connector 1 comes into contact with outer part 722 of mating side piece 72 of mating holding metal fitting 7 of mating connector 5 in a state where connector 1 is fitted to mating connector 5. According to this configuration, it is possible to ensure reliability of contact between spring piece 35 of holding metal fitting 3 and outer part 722 of mating side piece 72 of mating holding metal fitting 7 of mating connector 5 by the elastic force of spring piece 35 generated in the direction toward mating holding metal fitting 7. As a result, it is not necessary to bring portions (for example, inner part 312 of end piece 31, inner part 322 of side piece 32, inner part 362 of side extension piece 36) of holding metal fitting 3 other than spring pieces 35 into planar firm contact with mating holding metal fitting 7 (for example, outer part 712 of mating end piece 71 and outer part 722 of mating side piece 72), and it is possible to alleviate the insertion and removal force when mating connector 5 is fitted to connector 1. Consequently, connector 1 of the present exemplary embodiment has an advantage that at least one of the occurrence of damage when mating connector 5 is fitted to or removed from connector 1 and the degree of the damage can be suppressed.

When connector 1 and mating connector 5 are connected, mating peripheral wall 62 of mating connector 5 is fitted into first fitting recess 24 of connector 1. At this time, corners 623 at the four corners of mating peripheral wall 62 may come into contact with the inner surfaces of corners 223 at the four corners of peripheral wall 22 constituting the inner side surface of first fitting recess 24. Depending on the material of the contact portion, the contact portion may be scratched at the time of contact. Thus, in connector assembly 100 of the present exemplary embodiment, inner coupling part 332 of coupling part 33 of holding metal fitting 3 is provided at corner 223 of peripheral wall 22 of connector 1, and outer coupling part 732 of mating coupling part 73 of mating holding metal fitting 7 is provided at corner 623 of mating peripheral wall 62 of mating connector 5. Both inner coupling part 332 and outer coupling part 732 are made of metal and are less likely to be scratched. Thuds, in connector assembly 100 of the present exemplary embodiment, when connector 1 and mating connector 5 are connected, connector 1 is less likely to be scratched, and mating connector 5 is less likely to be scratched. In other words, there is an advantage that damage caused when mating connector 5 is fitted to connector 1 can be reduced. In addition, there is also an advantage that it is possible to suppress a decrease in strength of connector 1 and mating connector 5, and thus, it is possible to improve the strength of connector 1 and mating connector 5.

### (3) Modifications

The exemplary embodiment described above is merely one of various exemplary embodiments of the present disclosure. The exemplary embodiment described above can be variously changed according to a design and the like as long as the object of the present disclosure can be achieved. Hereinafter, modifications of the exemplary embodiment will be listed. Hereinafter, the exemplary embodiment may be referred to as “basic example”. The basic example and the modifications to be described below can be applied in appropriate combination.

### (3-1) Modification of Holding Metal Fitting

A modification of the holding metal fitting included in connector 1 (socket) will be described. Holding metal fitting 3A of a first modification and holding metal fitting 3B of a second modification described below may be provided in housing 2 instead of holding metal fitting 3 of the basic example. In such a case, the shape of housing 2 may be appropriately deformed according to the shapes of holding fittings 3A and 3B. Hereinafter, the same reference numerals are given to the same configurations as those of the holding metal fitting of the basic example or another modification, and the description thereof may be appropriately omitted. In the following description, holding metal fittings 3A and 3B attached to the right end of housing 2 will be described as an example.

### (3-1-1) First Modification of Holding Metal Fitting

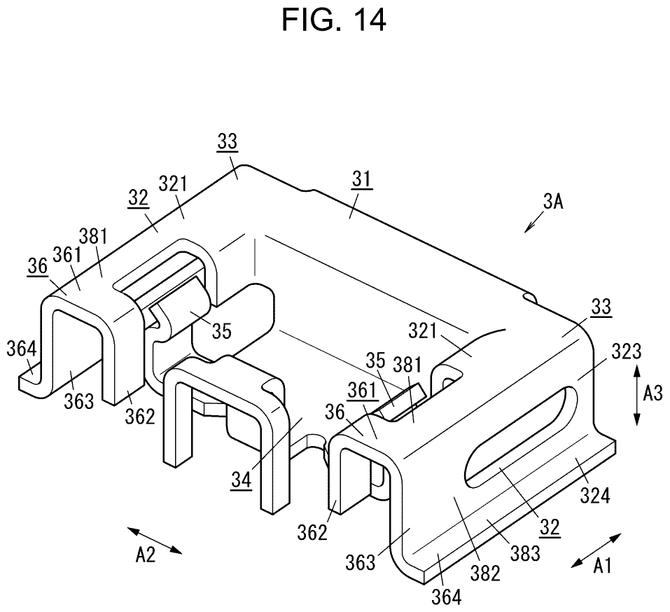

Holding metal fitting 3A of the first modification will be described with reference to FIG. 14.

Holding metal fitting 3A includes end piece 31, side piece 32, coupling part 33, intermediate extension 34, spring piece 35, side extension piece 36, upper extension 381, outer extension 382, and terminal extension 383. Specifically, holding metal fitting 3A includes one end piece 31, two side pieces 32, two coupling parts 33, one intermediate extension 34, two spring pieces 35, two side extension pieces 36, two upper extensions 381, two outer extensions 382, and two terminal extensions 383.

The first modification is different from the basic example in that two side extension pieces 36 are connected to another portion of holding metal fitting 3. More specifically, the first modification differs from the basic example in that two side extension pieces 36 are connected to the left end of side piece 32 via upper extension 381, outer extension 382, and terminal extension 383.

In the first modification, side extension piece 36 further includes terminal part 364 in addition to upper part 361, inner part 362, and outer part 363. Terminal part 364 has the same rectangular plate shape as outer part 363, and extends outward along second axis A2 from the lower end of outer part 323. The lower surface of terminal part 324 is a joint surface to be joined to first substrate 91 by soldering, for example.

Hereinafter, in principle, upper extension 381, outer extension 382, and terminal extension 383 provided on one side (front side) will be described as an example, and upper extension 381, outer extension 382, and terminal extension 383 provided on the other side (rear side) have the same structure.

Upper extension 381 couples upper part 321 of one (front side) side piece 32 and upper part 361 of one (front side) side extension piece 36. Specifically, upper extension 381 couples the left end of upper part 321 of one side piece 32 and the right end of upper part 361 of one side extension piece 36.

Upper extension 381 has a plate shape extending along the upper surface of side wall 222 of housing 2. That is, upper extension 381 can be regarded as a portion where the left end of upper part 321 of side piece 32 extends toward the right end of upper part 361 of side extension piece 36.

Similarly, outer extension 382 couples outer part 323 of one (front side) side piece 32 and outer part 363 of one (front side) side extension piece 36. Specifically, outer extension 382 couples the left end of outer part 323 in one side piece 32 and the right end of outer part 363 in one side extension piece 36.

Outer extension 382 has a plate shape extending along the outer side surface of side wall 222 of housing 2. That is, outer extension 382 can be regarded as a portion where the left end of outer part 323 of side piece 32 extends toward the right end of outer part 363 of side extension piece 36.

The upper end of outer extension 382 is connected to the outer end of upper extension 381. The corner connecting the upper end of outer extension 382 and the outer end of upper extension 381 is curved.

Terminal extension 383 couples terminal part 324 of one (front side) side piece 32 and terminal part 364 of one (front side) side extension piece 36. Specifically, terminal extension 383 couples the left end of terminal part 324 in one side piece 32 and the right end of terminal part 364 in one side extension piece 36.

Terminal extension 383 has a plate shape extending outward along second axis A2 from the lower end of outer extension 382. That is, terminal extension 383 can be regarded as a portion where the left end of terminal part 324 of side piece 32 extends toward the right end of terminal part 364 of side extension piece 36.

In the first modification, holding metal fitting 3A includes upper extension 381, outer extension 382, and terminal extension 383, but it may include at least one of upper extension 381, outer extension 382, and terminal extension 383. As an example, holding metal fitting 3A may include only upper extension 381. In other words, two side extension pieces 36 may be coupled to the left end of side piece 32 only via upper extension 381.

### (3-1-2) Second Modification of Holding Metal Fitting

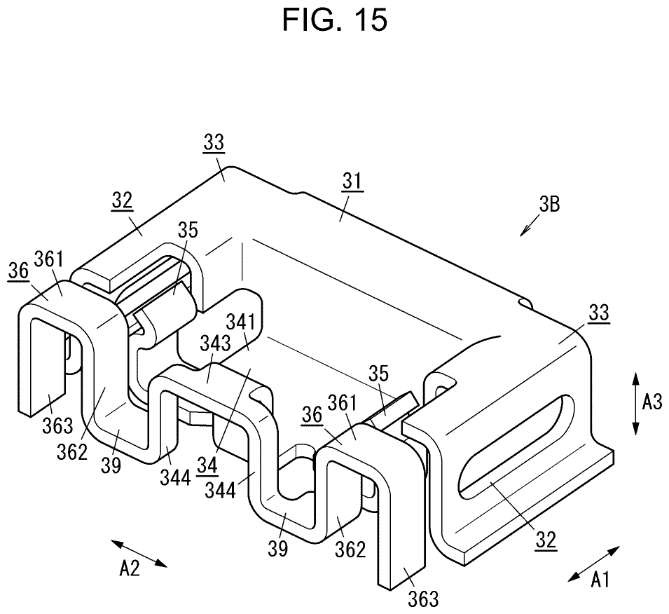

Holding metal fitting 3B of the second modification will be described with reference to FIG. 15.

The holding metal fitting 3B includes end piece 31, side piece 32, coupling part 33, intermediate extension 34, spring piece 35, side extension piece 36, and inner extension 39. Specifically, holding metal fitting 3B includes one end piece 31, two side pieces 32, two coupling parts 33, one intermediate extension 34, two spring pieces 35, two side extension pieces 36, and two inner extensions 39.

The second modification is different from the basic example in that the two side extension pieces 36 are connected to another portion of holding metal fitting 3. More specifically, the second modification differs from the basic example in that two side extension pieces 36 are connected to the left end of side piece 32 via inner extension 39.

Hereinafter, in principle, inner extension 39 provided on one side (front side) will be described as an example, and inner extension 39 provided on the other side (rear side) has the same structure.

Inner extension 39 couples one (front side) falling part 344 and inner part 362 of one (front side) side extension piece 36. Specifically, inner extension 39 couples the lower end of one falling part 344 and the lower end of inner part 362 of one (front side) side extension piece 36.

Inner extension 39 has a substantially rectangular plate shape extending outward along second axis A2 from the lower end of falling part 344. That is, inner extension 39 can be regarded as a portion in which the lower end of falling part 344 extends toward the lower end of inner part 362 of side extension piece 36. The upper surface of inner extension 39 is connected to the upper surface of bottom wall 21 of the housing without a step.

### (3-1-3) Other Modifications of Holding Metal Fitting

In one modification, holding metal fitting 3 may be disposed only at one end (left end or right end) in first axis A1 on peripheral wall 22 of housing 2.

In one modification, intermediate extension 34 may extend from side piece 32 toward intermediate base 23. In other words, bottom 341 of intermediate extension 34 may extend from the lower end of inner part 322 of side piece 32. Alternatively, intermediate extension 34 may integrally extend from end piece 31 and side piece 32 toward intermediate base 23. Bottom 341 of intermediate extension 34 may extend from the lower end of inner part 312 of end piece 31 and the lower end of inner part 322 of side piece 32.

In the basic example, each of outer part 313 of end piece 31 and outer part 323 of side piece 32 has buried parts 317 and 327, but in one modification, one of outer part 313 of end piece 31 and outer part 323 of side piece 32 may have buried parts 317 and 327.

That is, at least one of outer part 313 of end piece 31 and outer part 323 of side piece 32 has buried parts 317 and 327.

In the basic example, buried parts 317 and 327 have through hole 318, but in one modification, the buried parts may have a cutout. That is, buried parts 317 and 327 may have at least one of through hole 318 and a cutout. For example, the cutout of buried part 317 is provided at at least one end (at least one of the front end and the rear end) of outer part 313 in second axis A2. The cutout of buried part 317 may be provided at an end (lower end) of outer part 313 on terminal part 314 side. Similarly, the cutout of buried part 327 is provided at at least one end (at least one of the left end and the right end) of outer part 323 in first axis A1. The cutout of buried part 327 may be provided at an end (lower end) of outer part 323 on terminal part 324 side. The cutouts of buried parts 317 and 327 may have a rectangular shape, a semi-elliptical shape, or a semi-circular shape. That is, the shapes of the cutouts of buried parts 317 and 327 are not limited.

In one modification, holding metal fitting 3 (3A, 3B) does not have to include intermediate extension 34.

In one modification, holding metal fitting 3 (3A, 3B) does not have to include outer part 313 of end piece 31 and outer part 323 of side piece 32.

In one modification, holding metal fitting 3 (3A, 3B) may have a portion other than spring piece 35 in contact with mating holding metal fitting 7 in a state where connector 1 is fitted to mating connector 5. As an example, in a state where connector 1 is fitted to mating connector 5, bottom 341 of holding metal fitting 3 (3A, 3B) may be in contact with upper part 711 of mating end piece 71, upper part 721 of mating side piece 72, and upper coupling part 731 of mating coupling part 73 in mating connector 5.

In one modification, the structures of holding fittings 3, 3A, and 3B of the basic example and each modification may be partially combined. For example, holding metal fitting 3 of the basic example may further include upper extension 381, outer extension 382, and terminal extension 383 in addition to bottom extension 37. That is, in holding metal fitting 3 of the basic example, two side extension pieces 36 may be coupled to bottom 341 via bottom extension 37, and further coupled to side pieces 32 via upper extension 381, outer extension 382, and terminal extension 383.

Holding metal fitting 3A of the first modification may further include inner extension 39 in addition to upper extension 381, outer extension 382, and terminal extension 383. That is, in holding metal fitting 3A of the first modification, two side extension pieces 36 may be coupled to side pieces 32 via upper extension 381, outer extension 382, and terminal extension 383, and further coupled to falling part 344 via inner extension 39.

### (3-2) Other Modifications

In one modification, mating holding metal fitting 7 does not have to have inner part 713 of mating end piece 71 and inner part 723 of mating side piece 72.

In one modification, connector assembly 100 may be used in an electronic device other than a mobile terminal, such as a camera module, a wireless earphone, or a wearable terminal such as a smart watch. Connector assembly 100 is not limited to an application for electrically connecting the plurality of substrates 9, and the application may be an application for electrically connecting a plurality of components such as between substrate 9 and a display or between substrate 9 and a battery.

In one modification, the number of cores (the number of terminals 4 included in connector 1; the number of mating terminals 8 included in mating connector 5) can be changed as appropriate.

In one modification, the header to which connector 1 is connected is not limited to mating connector 5 described in the basic example.

### Conclusions

Connector 1 of a first aspect according to an exemplary embodiment is a connector to be fitted to mating connector 5, connector 1 including: housing 2 including peripheral wall 22, peripheral wall 22 including end wall 221 and end wall 221 facing each other in first axis A1, side wall 222 coupling one end of end wall 221 and one end of end wall 221, and side wall 222 coupling the other end of end wall 221 and the other end of end wall 221; holding metal fitting 3 (3A, 3B) disposed at, out of a first end of peripheral wall 22 in first axis A1 and a second end opposite to the first end, the first end; and terminal 4 held by peripheral wall 22 and electrically connected to mating terminal 8 of mating connector 5, in which connector 1 is fitted to mating connector 5 when connector 1 moves upward, holding metal fitting 3 (3A, 3B) includes: end piece 31 including upper part 311 disposed above end wall 221 and inner part 312 disposed inside end wall 221; side piece 32 including upper part 311 disposed above side wall 222 and inner part 322 disposed inside side wall 222; coupling part 33 disposed at a corner of peripheral wall 22 where end wall 221 and side wall 222 are connected to each other, the coupling part coupling end piece 31 and side piece 32 to each other; bottom 341 located between side wall 222 and side wall 222, the bottom extending from a lower end of end piece 31 or a lower end of side piece 32; and spring piece 35 extending upward from bottom 341, and coupling part 33 includes inner coupling part 332 connecting inner part 312 of end piece 31 and inner part 322 of side piece 32 without discontinuities.

According to this aspect, there is an advantage that connector 1 is less likely to be damaged at the time of fitting.

In connector 1 of a second aspect according to the exemplary embodiment, bottom 341 extends from a lower end of inner part 312 of end piece 31.

According to this aspect, there is an advantage that bottom 341 is easily formed.

In connector 1 of a third aspect according to the exemplary embodiment, inner coupling part 332 of coupling part 33 includes outer surface 3321 facing peripheral wall 22 and inner surface 3322 that is an opposite surface from outer surface 3321, and each of outer surface 3321 of inner coupling part 332 and inner surface 3322 of inner coupling part 332 is curved and protrudes outward with respect to a center of connector 1.

According to this aspect, there is an advantage that the strength of connector 1 is improved.

In connector 1 of a fourth aspect according to the exemplary embodiment, side wall 222 includes spring storage 28 that stores spring piece 35.

According to this aspect, there is an advantage that the size of connector 1 can be reduced.

In connector 1 of a fifth aspect according to the exemplary embodiment, holding metal fitting 3 (3A, 3B) further includes side extension piece 36 located between end piece 31 of holding metal fitting 3 (3A, 3B) and the second end wall of peripheral wall 22, side extension piece 36 includes inner part 362 disposed inside side wall 222, and spring piece 35 is disposed between inner part 322 of side piece 32 and inner part 362 of side extension piece 36.

According to this aspect, there is an advantage that spring piece 35 is less likely to be damaged.

In connector 1 of a sixth aspect according to the exemplary embodiment, holding metal fitting 3 further includes bottom extension 37 coupling bottom 341 and inner part 362 of side extension piece 36.

According to this aspect, there is an advantage that connector 1 is further less likely to be damaged at the time of fitting.

In connector 1 of a seventh aspect according to the exemplary embodiment, side extension piece 36 further includes upper part 361 disposed above end wall 221, upper part 361 of side extension piece 36 is disposed between upper part 321 of side piece 32 and end wall 221 of peripheral wall 22, and holding metal fitting 3A further includes upper extension 381 coupling upper part 321 of side piece 32 and upper part 361 of side extension piece 36.

According to this aspect, there is an advantage that connector 1 is further less likely to be damaged at the time of fitting.

In connector 1 of an eighth aspect according to the exemplary embodiment, housing 2 further includes intermediate base 23 located between the pair of side walls 222, the intermediate base protruding upward, and holding metal fitting 3B further includes: rising part 342 extending upward from bottom 341; upper end 343 extending from rising part 342 and disposed above intermediate base 23; falling part 344 extending downward from upper end 343; and inner extension 39 coupling falling part 344 and inner part 362 of side extension piece 36.

According to this aspect, there is an advantage that connector 1 is further less likely to be damaged at the time of fitting.

In connector 1 of a ninth aspect according to the exemplary embodiment, the housing further includes intermediate base 23 located between the pair of side walls 222, the intermediate base protruding upward, and holding metal fitting 3 (3A) further includes: rising part 342 extending upward from bottom 341; upper end 343 extending from rising part 342 and disposed above intermediate base 23; and falling part 344 extending downward from upper end 343.

According to this aspect, there is an advantage that intermediate base 23 is less likely to be damaged at the time of fitting.

In connector 1 of a tenth aspect according to the exemplary embodiment, side piece 32 of holding metal fitting 3 (3A, 3B) further includes outer part 313 disposed outside side wall 222, and at least one of outer part 313 of end piece 31 and outer part 323 of side piece 32 includes buried part 317 (327) buried in peripheral wall 22.

According to this aspect, there is an advantage that fixing strength between housing 2 and holding metal fitting 3 (3A, 3B) is improved.

In connector 1 of an eleventh aspect according to the exemplary embodiment, buried part 317 (327) includes at least one of through hole 318 (328) and a cutout.

According to this aspect, there is an advantage that adhesiveness between housing 2 and holding metal fitting 3 (3A, 3B) is improved.

In connector 1 of a twelfth aspect according to the exemplary embodiment, end piece 31 includes a fixing part (terminal part 314) to be fixed to substrate 9, and side piece 32 includes a fixing part (terminal part 324) to be fixed to substrate 9.

According to this aspect, there is an advantage that holding metal fitting 3 (3A, 3B) can be firmly fixed to substrate 9.

Connector 1 of a thirteenth aspect according to the exemplary embodiment is connector 1 to be fitted to mating connector 5, the mating connector including mating terminal 8, mating housing 6 holding mating terminal 8, and mating holding metal fitting 7 disposed in mating housing 6, in which spring piece 35 comes into contact with mating holding metal fitting 7 in a state where connector 1 is fitted to mating connector 5.

According to this aspect, there is an advantage that connector 1 is further less likely to be damaged at the time of fitting.

Mating connector 5 of a fourteenth aspect according to the exemplary embodiment is mating connector 5 to be fitted to connector 1, the mating connector including: mating housing 6 including mating peripheral wall 62, the mating peripheral wall including a pair of mating end walls 621 facing each other, mating side wall 622 coupling one end of one mating end wall 621 and one end of the other mating end wall 621, and mating side wall 622 coupling the other end of one mating end wall 621 and the other end of the other mating end wall 621; mating holding metal fitting 7 disposed at an end of mating peripheral wall 62 in first axis A1; and mating terminal 8, in which mating holding metal fitting 7 includes: mating end piece 71 including upper part 711 disposed above mating end wall 621 and outer part 712 disposed outside mating end wall 621; mating side piece 72 including upper part 721 disposed above mating side wall 622 and outer part 722 disposed outside mating side wall 622; and mating coupling part 73 disposed at corner 623 of mating peripheral wall 62 where mating end wall 621 and mating side wall 622 are connected, the mating coupling part coupling mating end piece 71 and mating side piece 72, and mating coupling part 73 includes outer coupling part 732 coupling outer part 712 of mating end piece 71 and outer part 722 of mating side piece 72 without discontinuities.

According to this aspect, there is an advantage that mating connector 5 is less likely to be damaged at the time of fitting.

Connector assembly 100 of a fifteenth aspect according to the exemplary embodiment is connector assembly 100 including a socket and a header to be fitted to the socket, in which the socket is connector 1 of any one of the first to thirteenth aspects described above, and the header is mating connector 5 of the fourteenth aspect described above.

According to this aspect, there is an advantage that connector 1 and mating connector 5 are less likely to be damaged at the time of fitting.

### REFERENCE MARKS IN THE DRAWINGS

100 connector assembly
1 connector
2 housing
22 peripheral wall
221 end wall
222 side wall
223 corner
23 intermediate base
28 spring storage
3, 3A, 3B holding metal fitting
31 end piece
311 upper part
312 inner part
313 outer part
317 buried part
318 through hole
32 side piece
321 upper part
322 inner part
3221 inner surface
323 outer part
327 buried part
328 through hole
33 coupling part
332 inner coupling part
3321 outer surface
3322 inner surface
333 slit
341 bottom
342 rising part
343 upper end
344 falling part
35 spring piece
351 rising part
36 side extension piece
361 upper part
362 inner part
363 outer part
37 bottom extension
381 upper extension
39 inner extension
4 terminal
5 mating connector
6 mating housing
62 mating peripheral wall
621 mating end wall
622 mating side wall
623 corner
7 mating holding metal fitting
71 mating end piece
711 upper part
712 outer part
713 inner part
72 mating side piece
721 upper part
722 outer part
723 inner part
73 mating coupling part
732 outer coupling part
8 mating terminal
A1 first axis
A2 second axis
A3 third axis

1. A connector to be fitted to a mating connector, the connector comprising:
a housing including a peripheral wall, the peripheral wall including
a first end wall and a second end wall facing each other in a first axis,
a first side wall coupling one end of the first end wall and one end of the second end wall, and
a second side wall coupling an other end of the first end wall and an other end of the second end wall;
a holding metal fitting disposed at, out of a first end of the peripheral wall in the first axis and a second end opposite to the first end, the first end; and
a terminal held by the peripheral wall and electrically connected to a mating terminal of the mating connector,
wherein the connector is fitted to the mating connector when the connector moves upward,
the holding metal fitting includes:
an end piece including an upper part disposed above the first end wall and an inner part disposed inside the first end wall;
a side piece including an upper part disposed above the first side wall and an inner part disposed inside the first side wall;
a coupling part disposed at a corner of the peripheral wall where the first end wall and the first side wall are connected to each other, the coupling part coupling the end piece and the side piece to each other;
a bottom located between the first side wall and the second side wall, the bottom extending from a lower end of the end piece or a lower end of the side piece; and
a spring piece extending upward from the bottom, and
the coupling part includes an inner coupling part connecting the inner part of the end piece and the inner part of the side piece without discontinuities.

2. The connector according to claim 1, wherein the bottom extends from a lower end of the inner part of the end piece.

3. The connector according to claim 1, wherein
the inner coupling part of the coupling part includes an outer surface facing the peripheral wall and an inner surface that is an opposite surface from the outer surface, and
each of the outer surface of the inner coupling part and the inner surface of the inner coupling part is curved and protrudes outward with respect to a center of the connector.

4. The connector according to claim 1, wherein the first side wall includes a spring storage that stores the spring piece.

5. The connector according to claim 1, wherein
the holding metal fitting further includes a side extension piece located between the end piece of the holding metal fitting and the second end wall of the peripheral wall,
the side extension piece includes an inner part disposed inside the first side wall, and
the spring piece is disposed between the inner part of the side piece and the inner part of the side extension piece.

6. The connector according to claim 5, wherein the holding metal fitting further includes a bottom extension coupling the bottom and the inner part of the side extension piece.

7. The connector according to claim 5, wherein
the side extension piece further includes an upper part disposed above the first end wall,
the upper part of the side extension piece is disposed between the upper part of the side piece and the second end wall of the peripheral wall, and
the holding metal fitting further includes an upper extension coupling the upper part of the side piece and the upper part of the side extension piece.

8. The connector according to claim 5, wherein
the housing further includes an intermediate base located between the first side wall and the second side wall, the intermediate base protruding upward, and
the holding metal fitting further includes:
a rising part extending upward from the bottom;
an upper end extending from the rising part and disposed above the intermediate base;
a falling part extending downward from the upper end; and
an inner extension coupling the falling part and the inner part of the side extension piece.

9. The connector according to any one of claims 1 to 7, wherein
the housing further includes an intermediate base located between the first side wall and the second side wall, the intermediate base protruding upward, and
the holding metal fitting further includes:
a rising part extending upward from the bottom;
an upper end extending from the rising part and disposed above the intermediate base; and
a falling part extending downward from the upper end.

10. The connector according to claim 1, wherein
the side piece of the holding metal fitting further includes an outer part disposed outside the first side wall, and
at least one of the outer part of the end piece and the outer part of the side piece includes a buried part buried in the peripheral wall.

11. The connector according to claim 10, wherein the buried part includes at least one of a through hole and a cutout.

12. The connector according to claim 1, wherein
the end piece includes a fixing part to be fixed to a substrate, and
the side piece includes a fixing part to be fixed to the substrate.

13. The connector according to claim 1 to be fitted to the mating connector, the mating connector including the mating terminal, a mating housing holding the mating terminal, and a mating holding metal fitting disposed in the mating housing,
wherein the spring piece comes into contact with the mating holding metal fitting in a state where the connector is fitted to the mating connector.

14. A mating connector to be fitted to the connector according to Claim 1, the mating connector comprising:
a mating housing including a mating peripheral wall, the mating peripheral wall including
a first mating end wall and a second mating end wall facing each other,
a first mating side wall coupling one end of the first mating end wall and one end of the second mating end wall, and
a second mating side wall coupling an other end of the first mating end wall and an other end of the second mating end wall;
a mating holding metal fitting disposed at the first end of the mating peripheral wall in the first axis; and
the mating terminal,
wherein the mating holding metal fitting includes:
a mating end piece including an upper part disposed above the first mating end wall and an outer part disposed outside the first mating end wall;
a mating side piece including an upper part disposed above the first mating side wall and an outer part disposed outside the first mating side wall; and
a mating coupling part disposed at a corner of the mating peripheral wall where the first mating end wall and the first mating side wall are connected, the mating coupling part coupling the mating end piece and the mating side piece, and
the mating coupling part includes an outer coupling part coupling the outer part of the mating end piece and the outer part of the mating side piece without discontinuities.

15. A connector assembly comprising:
a socket; and
a header to be fitted to the socket,
wherein the socket is the connector according to claim 1, and
the header is the mating connector according to claim 1.
